(19) United States
(12) Patent Application Publication
(10) Pub. No.: US 2023/0026405 A1
(43) Pub. Date: Jan. 26, 2023

(54) INKJET PRINTER AND METHOD FOR CONTROLLING INKJET PRINTER

(71) Applicant: MIMAKI ENGINEERING CO., LTD., Nagano (JP)

(72) Inventors: Yutaro Kishida, Nagano (JP); Soichiro Takehana, Nagano (JP)

(73) Assignee: MIMAKI ENGINEERING CO., LTD., Nagano (JP)

(21) Appl. No.: 17/785,915

(22) PCT Filed: Dec. 4, 2020
(86) PCT No.: PCT/JP2020/045223

§ 371 Date: Jun. 16, 2022

(30) Foreign Application Priority Data
Dec. 19, 2019 (JP) 2019-228745
Dec. 19, 2019 (JP) 2019-229026
Jan. 31, 2020 (JP) 2020-014590

(51) Int. Cl. B41J 2/045; B41J 2/17; B41J 2/125

(52) U.S. Cl. CPC B41J 2/04563; B41J 2/125; B41J 2/1714

(57) ABSTRACT

[Object] To appropriately warm ink.

[Solving Means] An inkjet printer 1 includes an inkjet head 3 and an ink warming mechanism 12. The ink warming mechanism 12 includes a warming part main body 21; an ink flow path 21a formed inside the warming part main body 21; a heater 22 that is attached to the warming part main body 21 and heats the warming part main body 21; a warming part temperature sensor 23 that is attached to the warming part main body 21 and detects a temperature of the warming part main body 21; and a heater controller 4 that controls the heater 22. The heater controller 24 controls the heater 22 based on the detection result of the warming part temperature sensor 23 so that the temperature of the warming part main body 21 becomes a predetermined reference temperature.

### TECHNICAL FIELD

The present invention relates to an inkjet printer and a method for controlling the inkjet printer.

### BACKGROUND ART

The inkjet printer includes an inkjet head that ejects ink, a carriage on which the inkjet head is mounted, and a carriage drive mechanism that moves the carriage in a main scanning direction. The inkjet printer includes a mechanism for adjusting the viscosity by warming ink when using, for example, ultraviolet curable ink having high viscosity.

For example, Patent Literature 1 proposes providing a preheating plate and a preheating heater, which are warming mechanisms, in an ink supplying device that supplies ink to a print head chip. In the ink supplying device described in Patent Literature 1, the ink flows into an ink storage part through the preheating plate. The preheating heater is disposed between the preheating plate and the ink storage part. The preheating heater warms the ink passing through the preheating plate and warms the ink contained in the ink storage part.

A temperature sensor is attached to the surface of the preheating plate. In Patent Literature 1, the temperature detected by the temperature sensor is compared with a reference temperature set in advance, and the supply of power to the preheating heater is controlled to warm the ink.

Patent Literature 2 proposes a structure for warming ink in an inkjet head. An ink supply port is provided at an upper part of the inkjet head, and a nozzle row configured by a plurality of nozzles that eject ink is provided at a lower part. The heater is disposed between the ink supply port and the nozzle row. The ink flowing into the inkjet head from the ink supply port is warmed by the heater.

### CITATION LIST

### Patent Literature

Patent Literature 1: Japanese Unexamined Patent Publication No. 2006-213061

Patent Literature 2: Japanese Unexamined Patent Publication No. 2012-232595

### SUMMARY OF INVENTION

### Technical Problems

In the ink supplying device described in Patent Literature 1, the passing time of the ink passing through the preheating plate and the ink storage part increases or decreases according to the supply amount per unit time of the ink supplied from the ink storage part to the print head chip. When the passing time decreases, the ink is not sufficiently heated, and the viscosity of the ink may become high. On the other hand, when the passing time becomes long, the temperature of the ink becomes high, and the viscosity of the ink may become lower than necessary.

Furthermore, in the ink supplying device described in Patent Literature 1, a temperature sensor is attached to the surface of the preheating plate. Therefore, the heat of the preheating heater is easily directly transferred to the temperature sensor through the preheating plate, and the influence of the preheating heater on the detection result of the temperature sensor may become large. As a result, the ink cannot be warmed to an appropriate temperature based on the detection result of the temperature sensor, and the variation in viscosity of the ink supplied to the print head chip may increase.

Furthermore, when warming is performed in the inkjet head as in Patent Literature 2, variation may occur in the ink temperature depending on the region in the inkjet head. For example, when the environmental temperature in which the inkjet printer is installed is low, the temperature of the ink in the region close to the ink supply port tends to be low, and the temperature of the ink in the region far from the ink supply port tends to be high. The viscosity of the ink varies by the variation in the temperature of the ink. The variation in viscosity of the ink leads to a difference in ejection speed from the nozzle. As a result, the print quality may not be stable.

In an inkjet printer, it is required to appropriately warm the ink and improve the quality of printing.

### Solutions to Problems

In order to solve the problems described above, an inkjet printer of the present invention includes an inkjet head that ejects ink, and an ink warming mechanism that warms the ink supplied to the inkjet head. The ink warming mechanism includes a block-shaped warming part main body; an ink passing portion that is formed inside the warming part main body and through which ink ejected from the inkjet head passes; a heater that is attached to the warming part main body and heats the warming part main body; a temperature sensor that is attached to the warming part main body and detects a temperature of the warming part main body; and a heater controller that controls the heater. The ink passing portion is configured by at least one of an ink flow path through which ink flows and an ink reservoir in which ink is accumulated. The heater controller controls the heater based on a detection result of the temperature sensor so that a temperature of the warming part main body becomes a predetermined reference temperature, and calculates a temperature reduction amount of the warming part main body due to an influence of the ink flowing into the ink passing portion based on a detection result of the temperature sensor after the inkjet head starts ejecting the ink Thereafter, the heater controller updates the reference temperature based on the calculated temperature reduction amount of the warming part main body.

In order to solve the problems described above, a method for controlling an inkjet printer of the present invention includes an inkjet head that ejects ink, and an ink warming mechanism that warms the ink supplied to the inkjet head. The ink warming mechanism includes a block-shaped warming part main body; an ink passing portion that is formed inside the warming part main body and through which ink passes; a heater that is attached to the warming part main body and heats the warming part main body; and a temperature sensor that is attached to the warming part main body and detects a temperature of the warming part main body. The ink passing portion is configured by at least one of an ink flow path through which ink flows and an ink reservoir in which ink is accumulated. In the method for controlling the inkjet printer, the heater is controlled based on a detection result of the temperature sensor so that a temperature of the warming part main body becomes a predetermined reference temperature, a temperature reduction amount of the warming part main body due to an influence of the ink flowing into the ink passing portion is calculated based on a detection result of the temperature sensor after the inkjet head starts ejecting the ink, and the reference temperature is updated based on the calculated temperature reduction amount of the warming part main body.

In the present invention, the heater is controlled based on the detection result of the temperature sensor so that the temperature of the warming part main body becomes a predetermined reference temperature. In the present invention, the temperature reduction amount of the warming part main body due to the influence of the ink flowing into the ink passing portion is calculated based on the detection result of the temperature sensor after the ejection of the ink from the inkjet head is started, and updates the reference temperature based on the calculated temperature reduction amount of the warming part main body.

Therefore, in the present invention, when it is estimated that the temperature reduction amount of the warming part main body due to the influence of the ink flowing into the ink passing portion is large and the inflow amount per unit time of the ink flowing into the ink passing portion is large, the reference temperature can be updated to a high temperature. Furthermore, in the present invention, when it is estimated that the temperature reduction amount of the warming part main body due to the influence of the ink flowing into the ink passing portion is small and the inflow amount per unit time of the ink flowing into the ink passing portion is small, the reference temperature can be updated to a low temperature.

Therefore, in the present invention, the heater is controlled based on the reference temperature updated to a high temperature and the detection result of the temperature sensor when the supply amount per unit time of the ink supplied from the ink warming mechanism to the inkjet head increases and the passing time of the ink passing through the ink passing portion becomes short. As a result, the ink supplied to the inkjet head can be warmed to a predetermined temperature. Moreover, in the present invention, the heater is controlled based on the reference temperature updated to a low temperature and the detection result of the temperature sensor when the supply amount per unit time of the ink supplied from the ink warming mechanism to the inkjet head decreases and the passing time of the ink passing through the ink passing portion becomes long. As a result, the ink supplied to the inkjet head can be prevented from being heated to higher than or equal to a predetermined temperature.

As described above, in the present invention, even when the passing time of the ink passing through the ink passing portion becomes short, the ink supplied to the inkjet head can be warmed to a predetermined temperature. Furthermore, in the present invention, even when the passing time of the ink passing through the ink passing portion becomes long, the ink supplied to the inkjet head can be prevented from being heated to higher than or equal to a predetermined temperature. Therefore, in the present invention, the variation in the viscosity of the ink supplied from the ink warming mechanism to the inkjet head can be suppressed.

In the present invention, the inkjet printer includes a second temperature sensor for detecting an external temperature of the inkjet printer. It is preferable that the heater controller initially sets the reference temperature based on the detection result of the second temperature sensor before ink is ejected from the inkjet head.

If the external temperature of the inkjet printer is high, the temperature of the ink flowing into the ink passing portion becomes high, and hence the ink supplied to the inkjet head can be warmed to a predetermined temperature even if the amount of heat applied to the ink passing through the ink passing portion is small. On the other hand, if the external temperature of the inkjet printer is low, the temperature of the ink flowing into the ink passing portion becomes low. Thus, unless the amount of heat applied to the ink passing through the ink passing portion is large, it is difficult to warm the ink supplied to the inkjet head to a predetermined temperature. In the present invention, when the external temperature of the inkjet printer is high, the reference temperature can be initially set to a low temperature based on the detection result of the second temperature sensor. Furthermore, in the present invention, when the external temperature of the inkjet printer is low, the reference temperature can be initially set to a high temperature based on the detection result of the second temperature sensor.

Therefore, when the external temperature of the inkjet printer is high, the heater is controlled based on the reference temperature initially set to a low temperature and the detection result of the temperature sensor. As a result, the ink supplied to the inkjet head can be warmed to a predetermined temperature. Moreover, when the external temperature of the inkjet printer is low, the heater is controlled based on the reference temperature initially set to a high temperature and the detection result of the temperature sensor. As a result, the ink supplied to the inkjet head can be warmed to a predetermined temperature. Therefore, the ink supplied to the inkjet head can be warmed to a predetermined temperature regardless of the external temperature of the inkjet printer. As a result, the variation in the viscosity of the ink supplied from the ink warming mechanism to the inkjet head can be suppressed regardless of the external temperature of the inkjet printer.

In order to solve the problems described above, an inkjet printer of the present invention includes an inkjet head that ejects ink, and an ink warming mechanism that warms the ink supplied to the inkjet head. The ink warming mechanism includes a block-shaped warming part main body; an ink passing portion that is formed inside the warming part main body and through which ink passes; a heater that is attached to the warming part main body and heats the warming part main body; a temperature sensor that is attached to the warming part main body and detects a temperature of the warming part main body; and a heater controller that controls the heater based on the detection result of the temperature sensor. The ink passing portion is configured by at least one of an ink flow path through which ink flows and an ink reservoir in which ink is accumulated. The warming part main body includes a heater attaching portion to which the heater is attached and a sensor attaching portion to which the temperature sensor is attached. Assuming that the flow direction of the ink flowing into the ink passing portion is the ink flow direction, the sensor attaching portion is provided to project out toward the upstream side in the ink flow direction of the heater attaching portion.

In the inkjet printer of the present invention, the heater attaching portion to which the heater is attached and the sensor attaching portion to which the temperature sensor is attached are formed in the warming part main body in which the ink passing portion is formed, and when the flow direction of the ink flowing into the ink passing portion is the ink flow direction, the sensor attaching portion is provided to project out toward the upstream side in the ink flow direction of the heater attaching portion. That is, in the present invention, the temperature sensor is attached to the sensor attaching portion projecting out toward the upstream side in the ink flow direction of the heater attaching portion.

Thus, in the present invention, the heat of the heater is less likely to be directly transferred to the temperature sensor, and the influence of the heater on the detection result of the temperature sensor can be reduced. Therefore, in the present invention, the temperature of the ink passing through the ink passing portion can be appropriately detected by the temperature sensor through the warming part main body, and as a result, the heater can be appropriately controlled so that the variation in the temperature of the ink supplied to the inkjet head is suppressed based on the appropriate detection result of the temperature sensor. Therefore, in the present invention, the variation in the viscosity of the ink supplied from the ink warming mechanism to the inkjet head can be suppressed.

Furthermore, in the present invention, since the temperature sensor is attached to the sensor attaching portion projecting out toward the upstream side in the ink flow direction of the heater attaching portion, the temperature of the ink before being warmed by the heater is easily reflected on the detection result of the temperature sensor. Therefore, in the present invention, it is possible to control the heater reflecting the external temperature (environmental temperature) of the inkjet printer based on the detection result of the temperature sensor. For example, when the external temperature of the inkjet printer is low and the temperature of the ink before being heated by the heater is low, the temperature detected by the temperature sensor tends to be low. Therefore, the heating temperature of the heater can be increased based on the detection result of the temperature sensor. When the external temperature of the inkjet printer is high and the temperature of the ink before being warmed by the heater is high, the temperature detected by the temperature sensor tends to be high. Therefore, the heating temperature of the heater can be lowered based on the detection result of the temperature sensor. As a result, in the present invention, the variation in the viscosity of the ink supplied from the ink warming mechanism to the inkjet head can be effectively suppressed.

Furthermore, in the present invention, since the sensor attaching portion is provided to project out toward the upstream side in the ink flow direction of the heater attaching portion, for example, it is not necessary to cut out a part of the heater attached to the heater attaching portion and attach the temperature sensor to the cut portion of the heater. Therefore, in the present invention, the heater can be attached to the entire heater attaching portion, and as a result, the heater can efficiently heat the warming part main body.

In the present invention, the inkjet printer includes a pressure adjustment mechanism that contains the ink supplied to the ink passing portion and adjusts the pressure of the ink supplied to the inkjet head. At least a part of the pressure adjustment mechanism is accommodated in the warming part main body, and a second ink flow path through which the ink flows is formed inside the pressure adjustment mechanism. It is preferable that the sensor attaching portion is provided in proximity to the second ink flow path. For example, the sensor attaching portion can be provided proximate to the outline surface of the portion of the pressure adjustment mechanism where the second ink flow path is formed. With such a configuration, the temperature of the ink before being warmed by the heater is easily reflected by the detection result of the temperature sensor. Therefore, it is possible to control the heater further reflecting the external temperature of the inkjet printer based on the detection result of the temperature sensor. As a result, the variation in the viscosity of the ink supplied from the ink warming mechanism to the inkjet head can be effectively suppressed.

In the present invention, it is preferable that the warming part main body includes an accommodating portion in which a part of the pressure adjustment mechanism is accommodated, and the sensor attaching portion constitutes a part of the accommodating portion. With this configuration, the temperature sensor can be attached to the warming part main body using the pressure adjustment mechanism accommodating portion in which a part of the pressure adjustment mechanism is accommodated. Therefore, even if the sensor attaching portion is formed in the warming part main body, the configuration of the warming part main body can be simplified.

In the present invention, for example, the pressure adjustment mechanism is disposed on the upper side of the ink passing portion, and the sensor attaching portion is disposed on the upper side of the heater attaching portion.

The inkjet printer of the present invention includes a plurality of inkjet heads that eject ink, and performs printing on a print medium by relatively moving the plurality of inkjet heads with respect to the print medium. The inkjet head includes a nozzle row in which a plurality of nozzles are formed along one direction, an ink supply port formed on one end portion side of the nozzle row, and an ink warming heater that warms ink, where the pair of inkjet heads are arranged adjacent to each other in a direction orthogonal to the one direction such that the one end portions of the nozzle row or the other end portions of the nozzle row are proximate to each other.

According to the present configuration, since the pair of inkjet heads are arranged such that the regions where the temperature of the ink in the inkjet head is the same are proximate to each other, an image with a more stable quality can be formed even with a device configuration of warming the ink in the inkjet head.

According to the inkjet printer of the present invention, when the pair of inkjet heads are driven simultaneously, the one end portions or the other end portions of the nozzle row are proximate to each other so that the respective nozzle rows of the pair of inkjet heads are regarded as a continuous nozzle row. According to this configuration, printing can be performed on the print medium by a long nozzle row in which nozzle rows of a pair of inkjet heads are continuous.

According to the inkjet printer of the present invention, the inkjet head performs printing on the print medium through a multi-pass method of performing a plurality of main scans for a plurality of print passes with respect to each position of the print medium, and in each of the plurality of print passes performed with respect to each position of the print medium, uses mask data, which is data designating the pixel to which ink droplet is to be ejected, and ejects the ink droplet to the pixel designated by the mask data; and the mask data is set so that a usage frequency of the nozzle on one end portion side proximate to each other in the nozzle row of the pair of inkjet heads becomes high and a usage frequency of the nozzle on the other end portion side separated in the nozzle row becomes low. According to such a configuration, since the temperature of the ink ejected from the nozzles having the same usage frequency is the same, an image with a more stable quality can be formed.

According to the inkjet printer of the present invention, the pair of inkjet heads are arranged such that regions where the temperature of the ink in the inkjet head is relatively low or regions where the temperature of the ink in the inkjet head is relatively high are proximate to each other. According to this configuration, an image with a more stable quality can be formed when the ink is warmed in the inkjet head.

### Effect of the Invention

As described above, in the present invention, the ink can be appropriately warmed and the print quality can be improved in the inkjet printer.

### BRIEF DESCRIPTION OF THE DRAWINGS

FIG. 1 is a perspective view of an inkjet printer according to a first embodiment of the present invention.

FIG. 2 is a schematic view for describing the configuration of the inkjet printer shown in FIG. 1.

FIG. 3 is a perspective view of a part of a peripheral portion of a carriage shown in FIG. 2.

FIG. 4 is a cross-sectional view of a pressure adjustment mechanism shown in FIG. 3.

FIG. 5 is a cross-sectional view for explaining a configuration of a warming part main body shown in FIG. 3.

FIG. 6 is a block diagram for explaining a configuration of an ink warming mechanism shown in FIG. 3.

FIG. 7 is a flowchart for explaining an example of a method for controlling a heater shown in FIG. 3.

FIG. 8 includes graphs for explaining an example of the method for controlling the heater shown in FIG. 3.

FIG. 9 is a diagram for explaining an example of a table stored in a heater controller shown in FIG. 6.

FIG. 10 is a flowchart for explaining an example of a method for controlling a heater according to a modified example of the first embodiment.

FIG. 11 is a perspective view of a part of a peripheral portion of a carriage of an inkjet printer according to a second embodiment of the present invention.

FIG. 12 is a schematic configuration diagram of an inkjet head.

FIG. 13 includes schematic views showing an arrangement example of a pair of inkjet heads.

(A) of FIG. 14 is a schematic view showing an arrangement example of an inkjet head of a comparative example, and (B) of FIG. 14 is a schematic view showing a usage frequency of a nozzle.

FIG. 15 includes schematic views showing another arrangement example of a plurality of inkjet heads.

### DESCRIPTION OF EMBODIMENTS

### First Embodiment

Hereinafter, a first embodiment of the present invention will be described with reference to the drawings.

### Schematic Configuration of Inkjet Printer

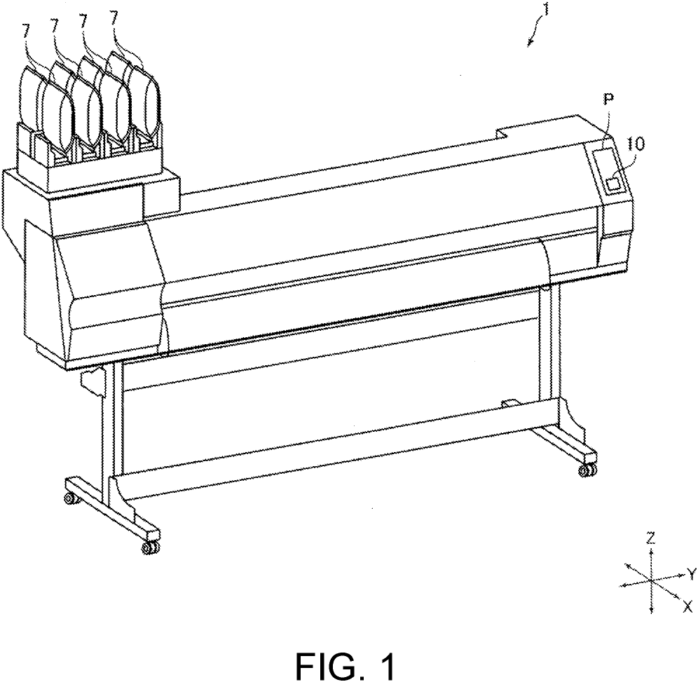

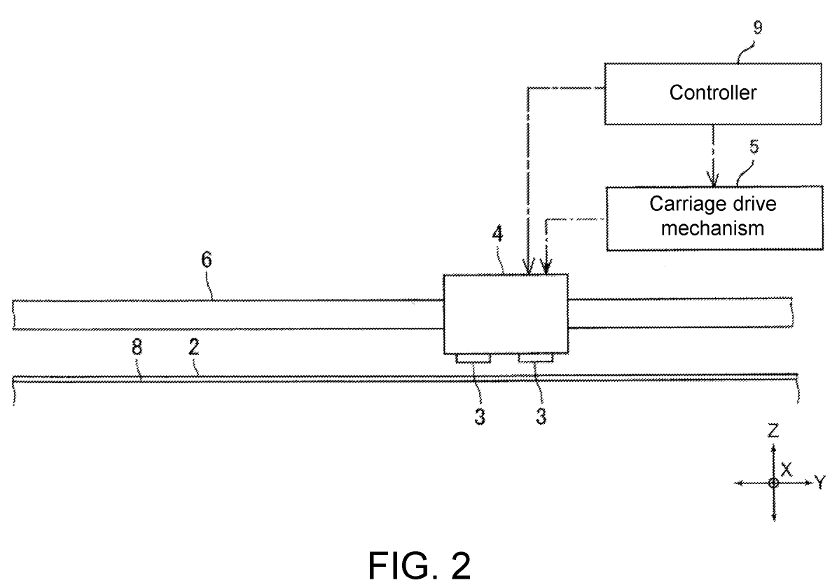

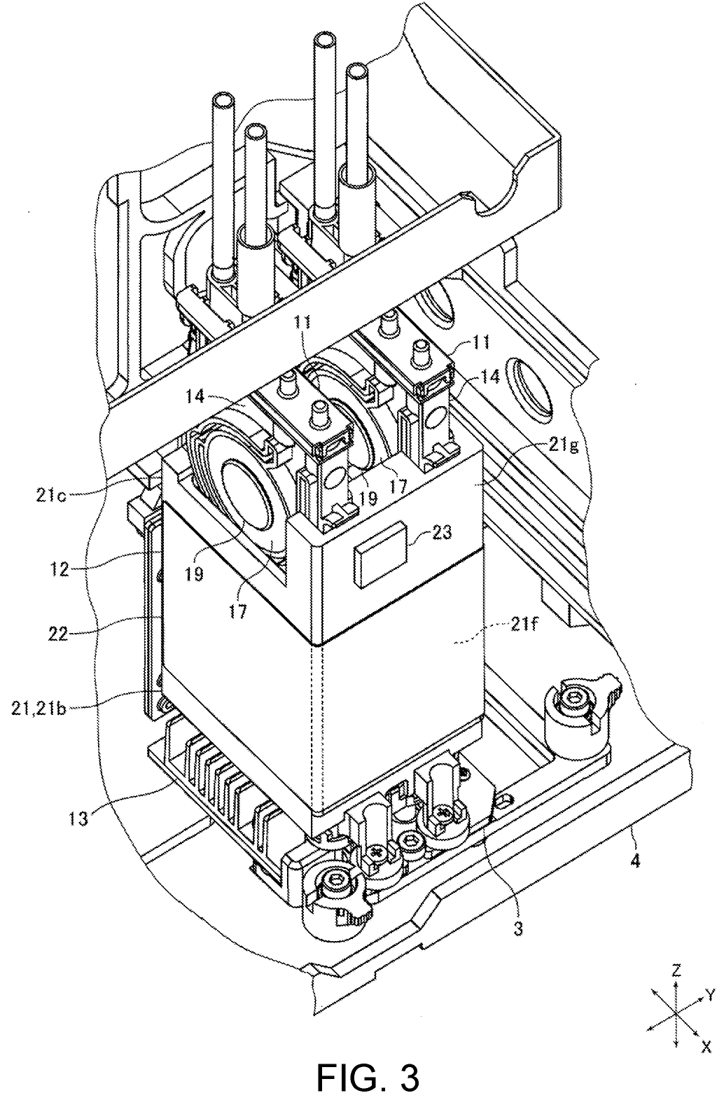

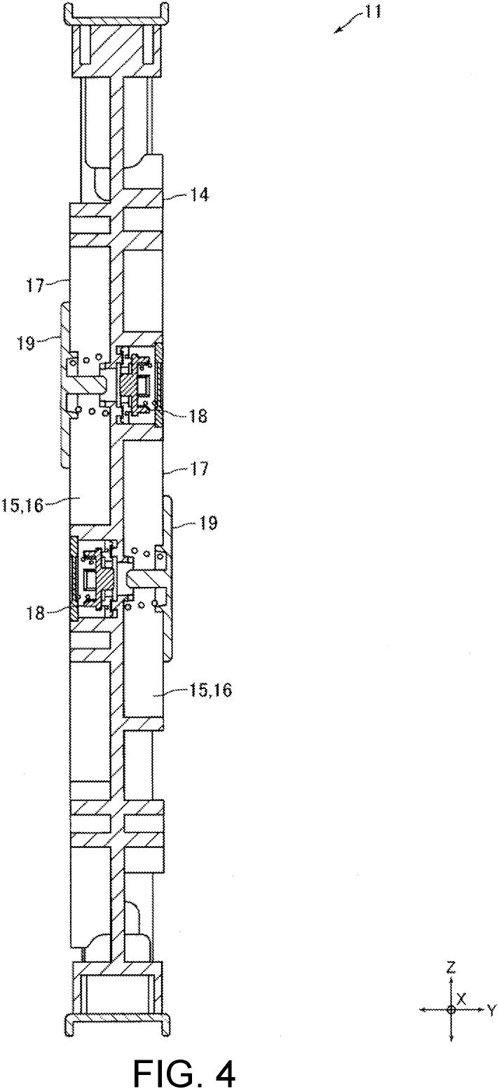

FIG. 1 is a perspective view of an inkjet printer 1 according to an embodiment of the present invention. FIG. 2 is a schematic view for describing the configuration of the inkjet printer 1 shown in FIG. 1. FIG. 3 is a perspective view of a part of a peripheral portion of a carriage 4 shown in FIG. 2. FIG. 4 is a cross-sectional view of a pressure adjustment mechanism 11 shown in FIG. 3.

As shown in FIGS. 1 and 2, the inkjet printer 1 (hereinafter also referred to as “printer 1”) of the present embodiment is, for example, a business inkjet printer, and performs printing on a print medium 2. The print medium 2 is, for example, printing paper, fabric, resin film, or the like. The printer 1 includes an inkjet head 3 (hereinafter also referred to as “head 3”) that ejects ink toward the print medium 2, a carriage 4 on which the head 3 is mounted, a carriage drive mechanism 5 that moves the carriage 4 in a main scanning direction (Y direction in FIG. 1, etc.), a guide rail 6 for guiding the carriage 4 in the main scanning direction, and a plurality of ink tanks 7 containing ink to be supplied to the head 3. In the following description, the main scanning direction (Y direction) is assumed as a “left-right direction” and a sub scanning direction (X direction in FIG. 1, etc.) orthogonal to the up-down direction (Z direction in FIG. 1, etc.) and the main scanning direction is assumed as a “front-back direction”.

A controller 9 arranged in the printer 1 includes, for example, a central processing unit (CPU) and the like. The controller 9 controls the operation of each part of the inkjet printer 1.

The head 3 ejects ultraviolet-curable ink (UV ink). The head 3 ejects ink toward the lower side. A nozzle surface (ink ejection surface) in which a plurality of nozzles are arrayed is formed on a lower surface of the head 3. The head 3 includes a piezoelectric element (piezoelectric element) for ejecting ink from the nozzle. As shown in FIG. 3, a heat sink 13 for dissipating heat generated by the head 3 (specifically, heat generated by the piezoelectric element) is attached to the upper surface of the head 3.

As shown in FIG. 2, a platen 8 is disposed on the lower side of the head 3. The print medium 2 at the time of printing is placed on the platen 8. The print medium 2 placed on the platen 8 is conveyed in the front-back direction by a medium feeding mechanism (not illustrated). The carriage drive mechanism 5 includes, for example, two pulleys, a belt that is bridged between the two pulleys and that has a part fixed to the carriage 4, and a motor that rotates the pulleys.

As illustrated in FIG. 1, the printer 1 includes a temperature sensor 10 (hereinafter, referred to as an “external temperature sensor 10”) for detecting an external temperature Ta of the printer 1. The external temperature sensor 10 is, for example, a thermistor. The external temperature sensor 10 is disposed on an operation panel P of the printer 1. The external temperature sensor 10 of the present embodiment is a second temperature sensor.

As shown in FIG. 3, the printer 1 includes the pressure adjustment mechanism 11 for adjusting the pressure of the ink supplied to the head 3, and an ink warming mechanism 12 for warming the ink supplied to the head 3. The ink warming mechanism 12 is disposed between the pressure adjustment mechanism 11 and the head 3 in the ink supply path to the head 3. Ink is supplied from the pressure adjustment mechanism 11 to the ink warming mechanism 12. The pressure adjustment mechanism 11 contains the ink to be supplied to the ink warming mechanism 12. Specifically, the pressure adjustment mechanism 11 contains ink to be supplied to an ink flow path 21 a formed inside the warming part main body 21 to be described later. The head 3 ejects the ink supplied from the ink warming mechanism 12. The pressure adjustment mechanism 11 and the ink warming mechanism 12 are mounted on the carriage 4.

Ink is supplied from the ink tank 7 (see FIG. 1) to the pressure adjustment mechanism 11. Specifically, the ink tank 7 is disposed on the upper side of the pressure adjustment mechanism 11, and ink is supplied from the ink tank 7 to the pressure adjustment mechanism 11 by a water head difference. The pressure adjustment mechanism 11 is a mechanical pressure damper, and mechanically adjusts the pressure of the ink supplied to the head 3 without using a pressure adjusting pump. Furthermore, the pressure adjustment mechanism 11 adjusts the pressure of the ink supplied to the head 3 so that the ink chamber formed inside the head 3 has a negative pressure.

As shown in FIG. 4, an ink flow path 15 through which ink flows is formed inside the pressure adjustment mechanism 11. Specifically, the ink flow path 15 is formed inside a main body frame 14 of the pressure adjustment mechanism 11. In the present embodiment, two ink flow paths 15 are formed inside the main body frame 14. A part of the ink flow path 15 is a pressure chamber 16 for making the internal pressure of the head 3 to a negative pressure. The ink flow path 15 of the present embodiment is a second ink flow path.

The pressure adjustment mechanism 11 includes a thin film-shaped flexible film 17 constituting a part of a wall surface of the pressure chamber 16. Furthermore, the pressure adjustment mechanism 11 includes a sealing valve 18 biased toward a closed position for stopping the inflow of ink into the pressure chamber 16, an opening valve 19 biased in a direction away from the sealing valve 18, and the like. The opening valve 19 is fixed to the flexible film 17, and the flexible film 17 is biased by a spring or the like in a direction in which the volume of the pressure chamber 16 increases. When the amount of ink in the pressure chamber 16 decreases, the opening valve 19 pushes the sealing valve 18 toward the open position at which the ink can flow into the pressure chamber 16. When the sealing valve 18 moves to the open position, the ink flows into the pressure chamber 16.

The pressure adjustment mechanism 11 is formed in a flat rectangular parallelepiped shape having a thin thickness in the left-right direction. As illustrated in FIG. 3, the pressure adjustment mechanism 11 is attached to the ink warming mechanism 12. In the present embodiment, two pressure adjustment mechanisms 11 are attached to one ink warming mechanism 12. The two pressure adjustment mechanisms 11 attached to one ink warming mechanism 12 are disposed so as to be adjacent to each other in the left-right direction.

### Configuration of Ink Warming Mechanism

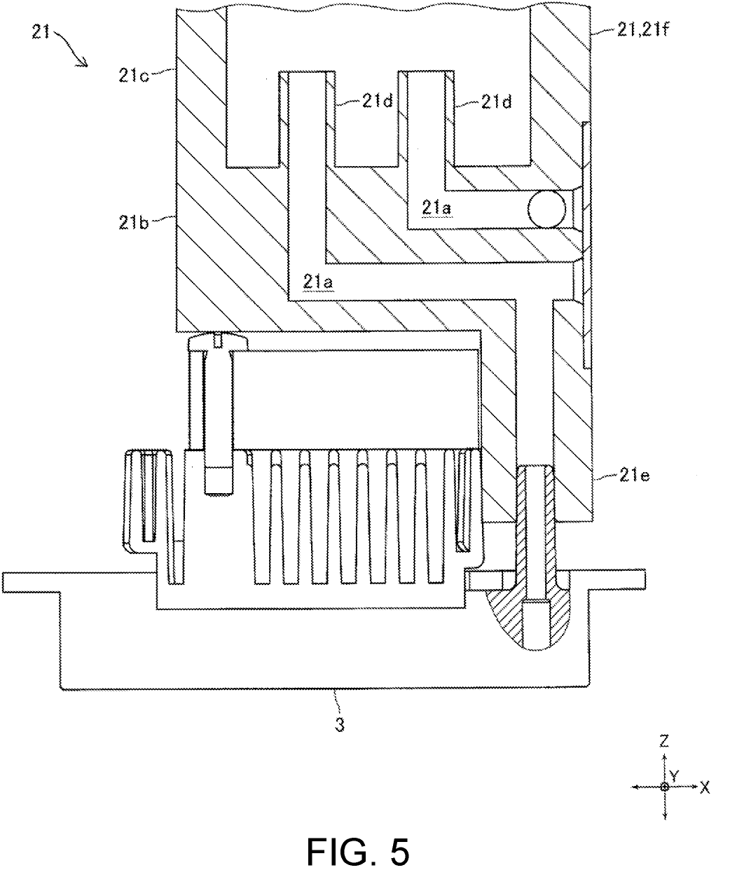

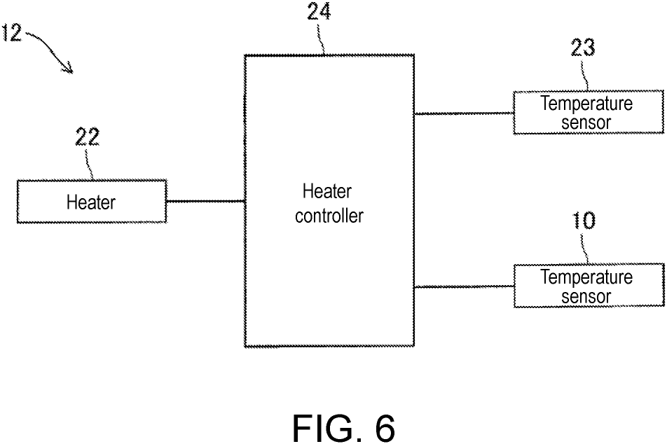

FIG. 5 is a cross-sectional view for explaining the configuration of the warming part main body 21 of the ink warming mechanism 12 shown in FIG. 3. FIG. 6 is a block diagram for explaining the configuration of the ink warming mechanism 12 shown in FIG. 3.

As shown in FIG. 3, the ink warming mechanism 12 is an ink-exterior ink warming device disposed exterior to the head 3. The ink warming mechanism 12 has a function of warming the ink supplied to the head 3 to lower the viscosity of the ink supplied to the head 3. The ink warming mechanism 12 is disposed on the upper side of the head 3. The ink warming mechanism 12 includes a warming part main body 21 formed in a block shape, a heater 22 attached to the warming part main body 21, and a temperature sensor 23 (hereinafter referred to as “warming part temperature sensor 23”) attached to the warming part main body 21.

The heater 22 is a sheet heater formed in a sheet shape. Furthermore, the heater 22 is a print heater including a conductive pattern and an insulating sheet (insulating film) that sandwiches the conductive pattern from both sides. In the present embodiment, one heater 22 is attached to the warming part main body 21. The heater 22 heats the warming part main body 21. The warming part temperature sensor 23 is, for example, a thermistor. The warming part temperature sensor 23 detects the temperature of the warming part main body 21. As shown in FIG. 6, the ink warming mechanism 12 includes a heater controller 24 that controls the heater 22 based on the detection result of the warming part temperature sensor 23. The heater 22 and the warming part temperature sensor 23 are electrically connected to the heater controller 24. Furthermore, an external temperature sensor 10 is electrically connected to the heater controller 24. The heater controller 24 may be common to the controller 9 in FIG. 1.

As shown in FIG. 3, the warming part main body 21 is formed to a substantially rectangular parallelepiped shape as a whole. The warming part main body 21 is made of a metal material having high thermal conductivity. For example, the warming part main body 21 is formed of an aluminum alloy. As shown in FIG. 5, an ink flow path 21a through which ink flows is formed inside the warming part main body 21. Specifically, a total of four ink flow paths 21a, two ink flow paths 21a through which ink supplied to the head 3 from one of the two pressure adjustment mechanisms 11 attached to the ink warming mechanism 12 flows, and two ink flow paths 21a through which ink supplied to the head 3 from the other pressure adjustment mechanism 11 flows are formed inside the warming part main body 21. In the present embodiment, the ink passing portion through which the ink passes is configured by the ink flow path 21a.

The ink flow path 21a is formed in a flow path forming portion 21b configuring the lower end portion of the warming part main body 21. An upper side of the flow path forming portion 21b is an accommodating portion 21c in which a lower side portion of the pressure adjustment mechanism 11 is accommodated. That is, the warming part main body 21 is formed with the accommodating portion 21c in which a part of the pressure adjustment mechanism 11 is accommodated, and a part of the pressure adjustment mechanism 11 is accommodated in the warming part main body 21. The accommodating portion 21c of the present embodiment is a pressure adjustment mechanism accommodating portion.

As described above, the upper side of the flow path forming portion 21b is the accommodating portion 21c, and the pressure adjustment mechanism 11 is disposed on the upper side of the ink flow path 21a. The accommodating portion 21c is formed in a box shape in which the upper surface side is opened. An ink inflow portion 21d through which ink flows in from the pressure adjustment mechanism 11 toward the ink flow path 21a is formed at an upper end of the flow path forming portion 21b. An ink outflow portion 21e through which ink flows out from the ink flow path 21a toward the head 3 is formed at a lower end of the flow path forming portion 21b.

As illustrated in FIG. 3, the heater 22 is attached to the left and right side surfaces and the front surface of the warming part main body 21. The upper end of the heater 22 is disposed on the lower side than the upper end (i.e., the upper end of the warming part main body 21) of the accommodating portion 21c. The upper end of the heater 22 is disposed on the upper side than the lower end (i.e., the upper end of the flow path forming portion 21b) of the accommodating portion 21c. The lower end of the heater 22 is disposed on the lower side than the lower end (i.e., the upper end of the flow path forming portion 21b) of the accommodating portion 21c. Furthermore, the lower end of the heater 22 is disposed on the upper side than the lower end (i.e., the lower end of the warming part main body 21) of the flow path forming portion 21b. A portion of the warming part main body 21 where the heater 22 is attached is a heater attaching portion 21f. That is, the heater attaching portion 21f where the heater 22 is attached is formed on the warming part main body 21.

The warming part temperature sensor 23 is attached to the front surface of the warming part main body 21. For example, the warming part temperature sensor 23 is fixed to the front surface of the warming part main body 21 by a screw (not illustrated). The warming part temperature sensor 23 is disposed on the upper side of the heater 22. That is, the warming part temperature sensor 23 is attached to the warming part main body 21 on the upper side than the heater attaching portion 21f. A portion of the warming part main body 21 where the warming part temperature sensor 23 is attached is a sensor attaching portion 21g. That is, the sensor attaching portion 21g where the warming part temperature sensor 23 is attached is formed on the warming part main body 21.

The sensor attaching portion 21g projects out toward the upper side from the heater attaching portion 21f. That is, a portion of the warming part main body 21 extending toward the upper side from the heater attaching portion 21f is the sensor attaching portion 21g, and the sensor attaching portion 21g is disposed on the upper side of the heater attaching portion 21f. The lower end of the sensor attaching portion 21g is connected to the upper end of the heater attaching portion 21f. The warming part temperature sensor 23 is attached to an upper end side portion of the front surface of the accommodating portion 21c. That is, the upper end side portion of the accommodating portion 21c is the sensor attaching portion 21g, and the warming part temperature sensor 23 is attached to the front surface of the sensor attaching portion 21g. The sensor attaching portion 21g constitutes a part of the accommodating portion 21c. Note that the warming part temperature sensor 23 may be attached to the left and right side surfaces (i.e., upper end side portions of the left and right side surfaces of the accommodating portion 21c) of the sensor attaching portion 21g.

The sensor attaching portion 21g is disposed at substantially the same position as the pressure chamber 16 (see FIG. 4) of the pressure adjustment mechanism 11 in the up-down direction. That is, the sensor attaching portion 21g is disposed beside the pressure chamber 16. Furthermore, the sensor attaching portion 21g is proximate to the outline surface of the portion of the pressure adjustment mechanism 11 where the ink flow path 15 is formed. Specifically, the sensor attaching portion 21g is proximate to the outline surface of the portion of the main body frame 14 where the ink flow path 15 is formed. More specifically, the sensor attaching portion 21g is brought into contact with the outline surface of the portion of the main body frame 14 where the ink flow path 15 is formed. Note that a slight gap may be formed between the outline surface of the main body frame 14 where the ink flow path 15 is formed and the sensor attaching portion 21g.

The pressure adjustment mechanism 11 is disposed on the upper side of the ink flow path 21a (see FIG. 5), and ink flows toward the lower side into the ink flow path 21a. That is, in the present embodiment, assuming that the flow direction (downward direction) of the ink flowing into the ink flow path 21a is the ink flow direction, the sensor attaching portion 21g is disposed on the upstream side (upper side) in the ink flow direction of the heater attaching portion 21f. That is, the sensor attaching portion 21g is provided to project out toward the upstream side (upper side) in the ink flow direction of the heater attaching portion 21f, and the warming part temperature sensor 23 is attached to the warming part main body 21 on the upstream side in the ink flow direction of the heater attaching portion 21f.

### Method for Controlling Heater

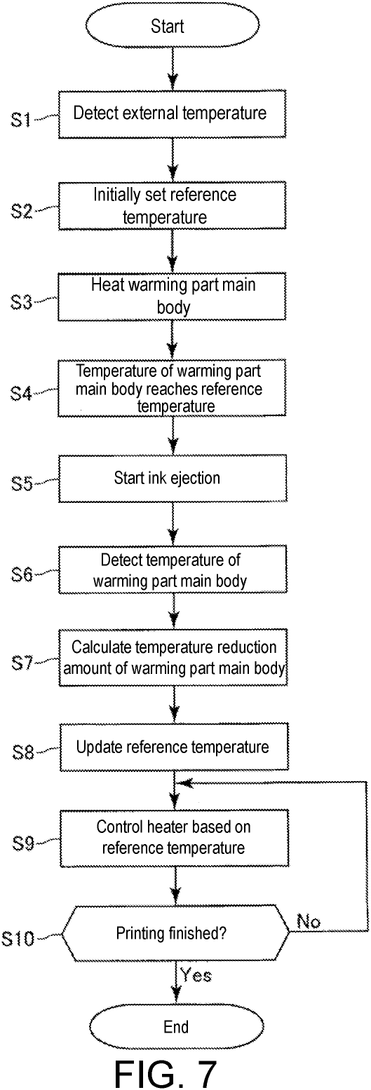

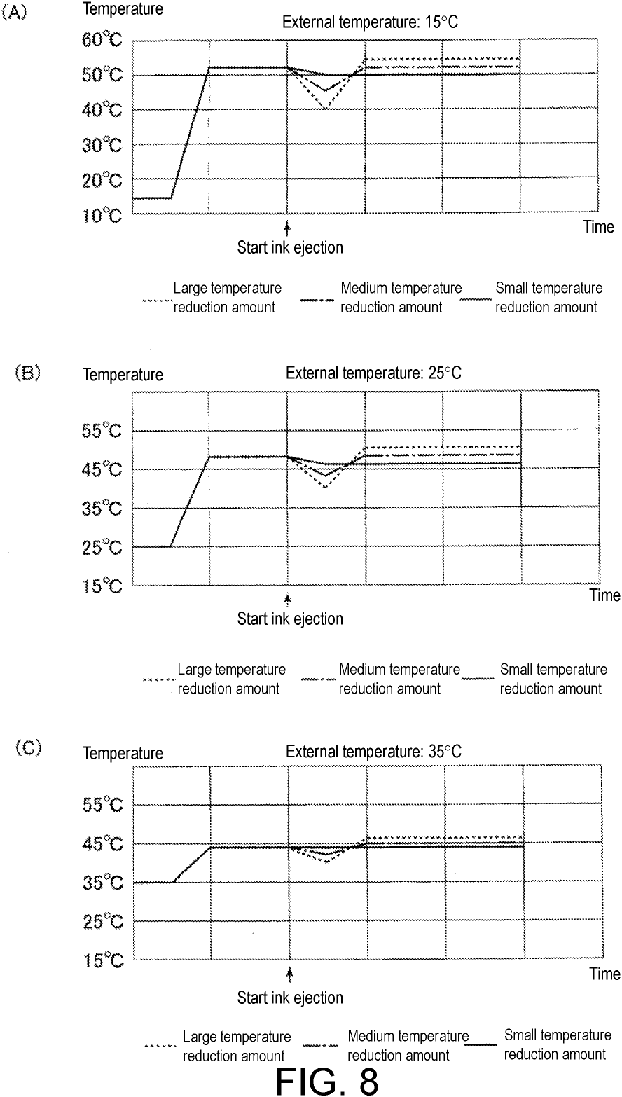

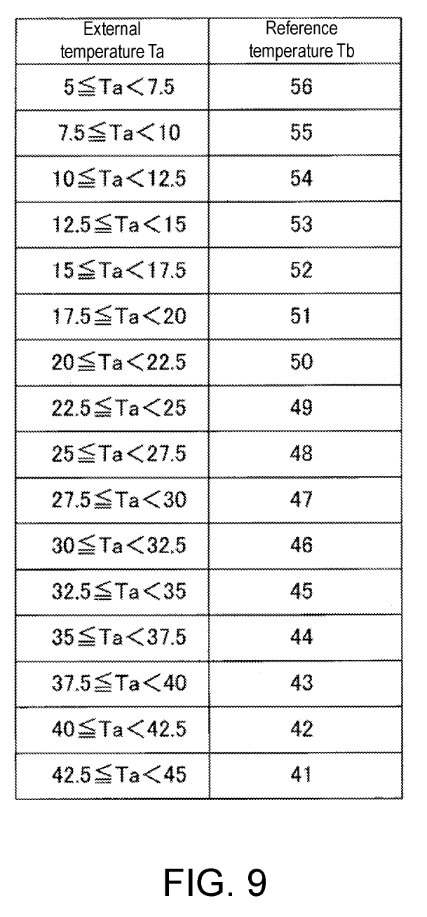

FIG. 7 is a flowchart for explaining an example of a method for controlling the heater 22 shown in FIG. 3. FIG. 8 is a graph for explaining an example of the method for controlling the heater 22 shown in FIG. 3. FIG. 9 is a diagram for explaining an example of a table stored in a heater controller 24 shown in FIG. 6.

The heater controller 24 controls the heater 22 based on the detection result of the warming part temperature sensor 23 (i.e., based on the temperature of the warming part main body 21) such that the temperature of the warming part main body 21 (more specifically, the temperature of the warming part main body 21 at the time of printing of the print medium 2) becomes a predetermined reference temperature Tb. Furthermore, the heater controller 24 initially sets the reference temperature Tb based on the detection result of the external temperature sensor 10 (i.e., based on the external temperature Ta of the printer 1) before the ink is ejected from the head 3. Furthermore, the heater controller 24 calculates the temperature reduction amount of the warming part main body 21 due to the influence of the ink flowing into the ink flow path 21a based on the detection result of the warming part temperature sensor 23 after the ejection of the ink from the head 3 is started, and updates the reference temperature Tb based on the calculated temperature reduction amount of the warming part main body 21.

Specifically, the heater controller 24 controls the heater 22 as follows. In the following, as an example of a method for controlling the heater 22, a method for controlling the heater 22 in a case where the optimum temperature of the ink supplied to the head 3 is about 45° C. will be described.

As illustrated in FIG. 7, for example, when a print command of the print medium 2 is input to the controller 9 of the printer 1, the heater controller 24 detects the external temperature Ta of the printer 1 by the external temperature sensor 10 (step S1). Thereafter, the heater controller 24 initially sets the reference temperature Tb based on the detection result of the external temperature sensor 10 in step S1 (step S2). More specifically, in step S2, the heater controller 24 initially sets the reference temperature Tb based on the optimum temperature of the ink supplied to the head 3 and the detection result of the external temperature sensor 10 in step S1.

Although an example is illustrated in FIG. 9, a plurality of ranges of the external temperature Ta detected by the external temperature sensor 10 and the reference temperature Tb associated with each range in advance are tabulated and stored in the heater controller 24. In the example of FIG. 9, one reference temperature Tb is set for the temperature range of 2.5° C., but the temperature range can be appropriately changed. The heater controller 24 refers the table and initially sets a reference temperature Tb associated with the external temperature Ta detected in step S1 in step S2.

For example, when the external temperature Ta of the printer 1 detected in step S1 is 15° C., the heater controller 24 initially sets the reference temperature Tb to 52° C. in step S2 (see (A) of FIG. 8). Furthermore, for example, when the external temperature Ta of the printer 1 detected in step S1 is 25° C., the heater controller 24 initially sets the reference temperature Tb to 48° C. in step S2 (see (B) of FIG. 8). When the external temperature Ta of the printer 1 detected in step S1 is 35° C., the heater controller 24 initially sets the reference temperature Tb to 44° C. in step S2 (see (C) of FIG. 8).

Thereafter, the heater controller 24 supplies power to the heater 22 to heat the warming part main body 21 (step S3). When the temperature of the warming part main body 21 heated by the heater 22 reaches the initially set reference temperature Tb (see (A), (B), and (C) of FIG. 8, and step S4), the head 3 starts the ejection of ink (step S5). That is, the ink starts to be ejected toward the print medium 2. When the head 3 starts to eject ink, the supply of ink from the ink warming mechanism 12 to the head 3 is started. When the ink in the ink flow path 21a flows downward, the ink flows from the pressure adjustment mechanism 11 into the ink flow path 21a. The temperature of the warming part main body 21 may reduce due to the influence of the ink flowing from the pressure adjustment mechanism 11 into the ink flow path 21a (see (A), (B), and (C) of FIG. 8).

When a predetermined time has elapsed after the start of ink ejection from the head 3, the heater controller 24 detects the temperature of the warming part main body 21 by the warming part temperature sensor 23 (step S6). Furthermore, the heater controller 24 calculates the temperature reduction amount of the warming part main body 21 based on the detection result of the warming part temperature sensor 23 in step S6 (step S7). That is, the heater controller 24 calculates the temperature reduction amount of the warming part main body 21 due to the influence of the ink flowing into the ink flow path 21a based on the detection result of the warming part temperature sensor 23 after the start of ejection of the ink from the head 3. Specifically, the heater controller 24 calculates, in step S7, a temperature reduction amount per unit time obtained by dividing a value obtained by subtracting the temperature of the warming part main body 21 detected in step S6 from the reference temperature Tb by the elapsed time from the start of ink ejection to step S6.

Thereafter, the heater controller 24 updates the reference temperature Tb based on the temperature reduction amount of the warming part main body 21 calculated in step S7 (step S8). For example, when the temperature reduction amount calculated in step S7 is large, the heater controller 24 updates the reference temperature Tb with a temperature higher than the reference temperature Tb set in step S2 as the reference temperature Tb (see broken lines in (A) to (C) of FIG. 8).

Furthermore, when the temperature reduction amount calculated in step S7 is small, the reference temperature Tb is updated in accordance with the external temperature Ta. For example, as illustrated in (A) and (B) of FIG. 8, when the external temperature Ta of the printer 1 detected in step S1 is 15° C. or 25° C. and the temperature reduction amount calculated in step S7 is small, the heater controller 24 updates the reference temperature Tb with a temperature lower than the reference temperature Tb set in step S2 as the reference temperature Tb (see solid lines in (A) and (B) of FIG. 8). On the other hand, as illustrated in (C) of FIG. 8, when the external temperature Ta of the printer 1 detected in step S1 is 35° C. and the temperature reduction amount calculated in step S7 is small, the heater controller 24 updates the reference temperature Tb with a temperature of the same degree as the reference temperature Tb set in step S2 as the reference temperature Tb (see solid line in (C) of FIG. 8).

Furthermore, when the temperature reduction amount calculated in step S7 is not large nor small, and is a medium degree, the reference temperature Tb is updated in accordance with the external temperature Ta. For example, as illustrated in (A) and (B) of FIG. 8, when the external temperature Ta of the printer 1 detected in step S1 is 15° C. or 25° C. and the temperature reduction amount calculated in step S7 is a medium degree, the heater controller 24 updates the reference temperature Tb with a temperature of the same degree as the reference temperature Tb set in step S2 as the reference temperature Tb (see dashed lines in (A) and (B) of FIG. 8). When the external temperature Ta of the printer 1 detected in step S1 is 35° C. and the temperature reduction amount calculated in step S7 is a medium degree, the heater controller 24 updates the reference temperature Tb with a temperature slightly higher than the reference temperature Tb set in step S2 as the reference temperature Tb (see dashed line in (C) of FIG. 8).

Thereafter, the heater controller 24 controls the heater 22 based on the reference temperature Tb updated in step S8 until the printing of the print medium 2 is finished (steps S9 and S10). Specifically, the heater controller 24 controls the heater 22 so that the temperature detected by the warming part temperature sensor 23 becomes the reference temperature Tb updated in step S8 until the printing of the print medium 2 is finished.

### Main Effects of First Embodiment

As described above, the inkjet printer 1 according to the first embodiment has the following configuration. (1) The inkjet printer 1 includes a head 3 (inkjet head) that ejects ink, and an ink warming mechanism 12 that warms the ink supplied to the head 3. The ink warming mechanism 12 includes:
a block-shaped warming part main body 21;
an ink flow path 21 a (ink passing portion) that is formed inside the warming part main body 21 and through which ink passes;
a heater 22 that is attached to the warming part main body 21 and heats the warming part main body 21;
a warming part temperature sensor 23 (temperature sensor) that is attached to the warming part main body 21 and detects a temperature of the warming part main body 21; and
a heater controller 24 that controls the heater 22.
The heater controller 24 controls the heater 22 based on the detection result of the warming part temperature sensor 23 so that the temperature of the warming part main body 21 becomes a predetermined reference temperature Tb. The heater controller 24 calculates the temperature reduction amount of the warming part main body 21 due to the influence of the ink flowing into the ink flow path 21a based on the detection result of the warming part temperature sensor 23, and updates the reference temperature Tb based on the calculated temperature reduction amount of the warming part main body 21.

In the first embodiment, the ink passing portion is configured as the ink flow path 21a, but the ink currency portion may be configured by at least one of the ink flow path and the ink reservoir in which the ink is accumulated.

Specifically, the heater controller 24 updates the initially set reference temperature Tb to a high temperature when it is estimated that the temperature reduction amount of the warming part main body 21 is large and the inflow amount per unit time of the ink flowing into the ink flow path 21a is large, and updates the initially set reference temperature Tb to a low temperature or updates the initially set reference temperature Tb to a temperature of the same degree when it is estimated that the temperature reduction amount of the warming part main body 21 is small and the inflow amount per unit time of the ink flowing into the ink flow path 21a is small.

Therefore, in the present embodiment, the heater 22 is controlled based on the reference temperature Tb updated to a high temperature and the detection result of the warming part temperature sensor 23 when the supply amount per unit time of the ink supplied from the ink warming mechanism 12 to the head 3 increases and the passing time of the ink passing through the ink flow path 21a becomes short. As a result, the ink supplied to the head 3 can be warmed to a predetermined temperature. Furthermore, in the present embodiment, the heater 22 is controlled based on the reference temperature Tb updated to a temperature of the same degree as the initially set reference temperature Tb or a low temperature and the detection result of the warming part temperature sensor 23 when the supply amount per unit time of the ink supplied from the ink warming mechanism 12 to the head 3 decreases and the passing time of the ink passing through the ink flow path 21a becomes long. As a result, the ink supplied to the head 3 can be prevented from being heated to higher than or equal to a predetermined temperature. Therefore, in the present embodiment, the variation in the viscosity of the ink supplied from the ink warming mechanism 12 to the head 3 can be effectively suppressed.

(2) The inkjet printer 1 includes an external temperature sensor 10 (second temperature sensor) for detecting an external temperature Ta of the inkjet printer 1. The heater controller 24 initially sets the reference temperature Tb based on the detection result of the external temperature sensor 10 before ink is ejected from the head 3.

If the external temperature Ta of the printer 1 is high and the temperature of the ink flowing into the ink flow path 21a is high, the ink supplied to the head 3 can be warmed to a predetermined temperature even if the amount of heat applied to the ink passing through the ink flow path 21a is small. If the external temperature Ta of the printer 1 is low and the temperature of the ink flowing into the ink flow path 21a is low, it is difficult to warm the ink supplied to the head 3 to a predetermined temperature unless the amount of heat applied to the ink passing through the ink flow path 21a is large. In the present embodiment, the heater controller 24 initially sets the reference temperature Tb based on the detection result of the external temperature sensor 10 before ink is ejected from the head 3. Specifically, the heater controller 24 sets the reference temperature Tb to a low temperature based on the detection result of the external temperature sensor 10 when the external temperature Ta of the printer 1 is high, and sets the reference temperature Tb to a high temperature based on the detection result of the external temperature sensor 10 when the external temperature Ta of the printer 1 is low.

Therefore, in the present embodiment, when the external temperature Ta of the printer 1 is high, the heater 22 is controlled based on the reference temperature Tb initially set to a low temperature and the detection result of the warming part temperature sensor 23. As a result, the ink supplied to the head 3 can be warmed to a predetermined temperature. In the present embodiment, when the external temperature Ta of the printer 1 is low, the heater 22 is controlled based on the reference temperature Tb initially set to a high temperature and the detection result of the warming part temperature sensor 23. As a result, the ink supplied to the head 3 can be warmed to a predetermined temperature. Therefore, in the present embodiment, the ink supplied to the head 3 can be warmed to a predetermined temperature regardless of the external temperature Ta of the printer 1. As a result, the variation in the viscosity of the ink supplied from the ink warming mechanism 12 to the head 3 can be suppressed regardless of the external temperature Ta of the printer 1.

The method for controlling the inkjet printer 1 performed by the heater controller 24 of the present embodiment can also obtain a similar effect.

(3) The warming part main body 21 includes a heater attaching portion 21f to which the heater 22 is attached and a sensor attaching portion 21g to which the warming part temperature sensor 23 is attached.

Assuming that the flow direction of the ink flowing into the ink flow path 21a is the ink flow direction, the sensor attaching portion 21g is provided to project out toward the upstream side in the ink flow direction of the heater attaching portion 21f.

With such a configuration, the heat of the heater 22 is less likely to be directly transferred to the warming part temperature sensor 23, and the influence of the heater 22 on the detection result of the warming part temperature sensor 23 can be reduced. Therefore, in the present embodiment, the temperature of the ink passing through the ink flow path 21a can be appropriately detected by the warming part temperature sensor 23 through the warming part main body 21, and as a result, the heater 22 can be appropriately controlled so that the variation in the temperature of the ink supplied to the head 3 is suppressed based on the appropriate detection result of the warming part temperature sensor 23. Therefore, in the present embodiment, the variation in the viscosity of the ink supplied from the ink warming mechanism 12 to the head 3 can be suppressed.

Furthermore, in the present embodiment, since the warming part temperature sensor 23 is attached to the sensor attaching portion 21g projecting out toward the upstream side in the ink flow direction of the heater attaching portion 21f, the temperature of the ink before being warmed by the heater 22 is easily reflected on the detection result of the warming part temperature sensor 23. Therefore, in the present embodiment, it is possible to control the heater 22 reflecting the external temperature Ta of the printer 1 based on the detection result of the warming part temperature sensor 23. As a result, in the present embodiment, the variation in the viscosity of the ink supplied from the ink warming mechanism 12 to the head 3 can be effectively suppressed.

(4) The inkjet printer 1 includes a pressure adjustment mechanism 11 that contains the ink supplied to the ink flow path 21a and adjusts the pressure of the ink supplied to the head 3.

At least a part of the pressure adjustment mechanism 11 is accommodated in the warming part main body 21.

An ink flow path 15 (second ink flow path) through which ink flows is formed inside the pressure adjustment mechanism 11. The sensor attaching portion 21g is provided in proximity to the second ink flow path.

Specifically, the sensor attaching portion 21g is proximate to the outline surface of the portion of the pressure adjustment mechanism 11 where the ink flow path 15 is formed. Therefore, the temperature of the ink before being warmed by the heater 22 is easily reflected by the detection result of the warming part temperature sensor 23. Therefore, in the present embodiment, it is possible to control the heater 22 more reflecting the external temperature Ta of the printer 1 based on the detection result of the warming part temperature sensor 23, and as a result, the variation in the viscosity of the ink supplied from the ink warming mechanism 12 to the head 3 can be more effectively suppressed.

In the present embodiment, the sensor attaching portion 21g projects out toward the upper side of the heater attaching portion 21f. Therefore, in the present embodiment, for example, it is not necessary to cut out a part of the heater 22 attached to the heater attaching portion 21f and attach the warming part temperature sensor 23 to the cut-out portion of the heater 22. Therefore, in the present embodiment, the heater 22 can be attached to the entire heater attaching portion 21f. As a result, the warming part main body 21 can be efficiently heated by the heater 22.

(5) An accommodating portion 21c in which a part of the pressure adjustment mechanism 11 is accommodated is formed in the warming part main body 21. The sensor attaching portion 21g constitutes a part of the accommodating portion 21c. Therefore, in the present embodiment, even if the sensor attaching portion 21g is formed in the warming part main body 21, the configuration of the warming part main body 21 can be simplified.

### Modified Example of First Embodiment

The first embodiment described above is an example of a preferred embodiment of the present invention, but this is not the sole case, and various modifications can be made within a scope no changing the gist of the present invention.

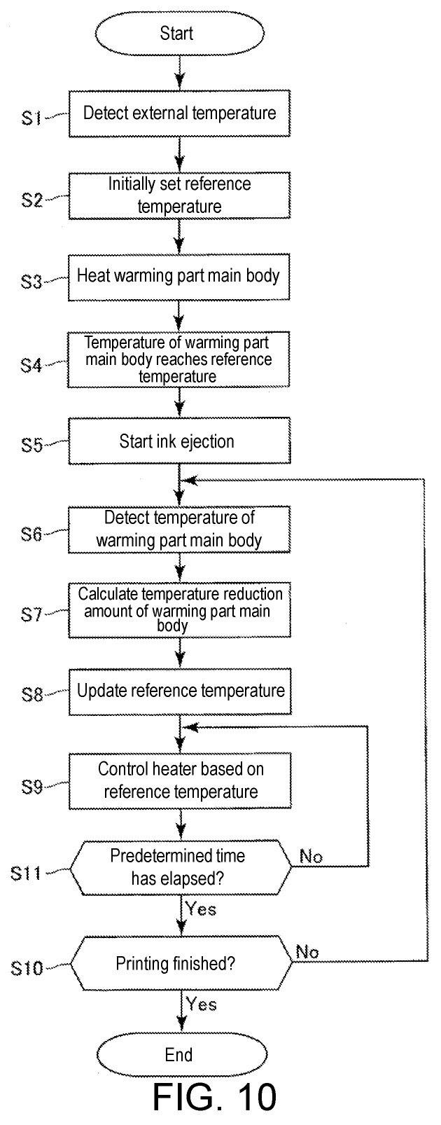

FIG. 10 is a flowchart for explaining an example of a method for controlling a heater according to a modified example of the first embodiment. Since steps S1 to S10 in FIG. 10 are the same as steps S1 to S10 in FIG. 7, detailed description thereof will be omitted.

As illustrated in FIG. 10, the heater controller 24 may control the heater 22 based on the reference temperature Tb updated in step S8 until a predetermined time has elapsed after the reference temperature Tb is updated in step S8 (steps S9 and S11). For example, the heater controller 24 may control the heater 22 based on the reference temperature Tb updated in step S8 until the printing operation of one scan by the head 3 is completed. In this case, for example, when a predetermined time has elapsed after the reference temperature Tb is updated in step S8, the process proceeds to step S10, and when the printing of the print medium 2 has not finished, the process returns to step S6.

Specifically, in step S7 after step S10, the heater controller 24 calculates a temperature reduction amount per unit time obtained by dividing a value obtained by subtracting the temperature of the warming part main body 21 detected in step S6 of this time from the reference temperature Tb updated in step S8 of previous time by a predetermined elapsed time. The heater controller 24 then updates the reference temperature Tb again based on the calculated temperature reduction amount (step S8). During the printing of the print medium 2, the supply amount per unit time of the ink supplied from the ink warming mechanism 12 to the head 3 may fluctuate. The modified example can respond to a case where the temperature of the warming part main body 21 fluctuates due to the fluctuation in the supply amount, and variation in the viscosity of the ink supplied from the ink warming mechanism 12 to the head 3 can be suppressed.

In the embodiment described above, the warming part temperature sensor 23 may be attached to the inside (i.e., inside of the upper end side portion of the accommodating portion 21c) of the sensor attaching portion 21g. In the embodiment described above, the external temperature sensor 10 may be attached to the main body frame of the printer 1 or may be mounted on the carriage 4. In the embodiment described above, the warming part temperature sensor 23 may detect the external temperature Ta of the printer 1 as long as the warming part temperature sensor 23 can appropriately detect the external temperature Ta of the printer 1. That is, the temperature sensor that detects the external temperature Ta of the printer 1 and the temperature sensor that detects the temperature of the warming part main body 21 may be the common warming part temperature sensor 23.

In the embodiment described above, the heater controller 24 performs the initial setting of the reference temperature Tb based on the external temperature Ta of the printer 1 detected by the external temperature sensor 10, but the heater controller 24 may perform the initial setting of the reference temperature Tb according to the specification of the ink supplied to the head 3 (specifically, according to the optimum temperature of the ink supplied to the head 3). In the embodiment described above, the heater controller 24 may not update the reference temperature Tb.

In the embodiment described above, the entire pressure adjustment mechanism 11 may be accommodated in the accommodating portion 21c. Furthermore, in the embodiment described above, a large gap may be formed between the outline surface of the portion where the ink flow path 15 is formed in the main body frame 14 and the sensor attaching portion 21g. Furthermore, in the embodiment described above, the heater 22 may be a heater other than the sheet heater. In the embodiment described above, the number of ink flow paths 21a formed in the warming part main body 21 may be 3 or less, or may be 5 or more.

In the embodiment described above, instead of the ink flow path 21a, an ink reservoir (ink chamber) in which ink is accumulated may be formed inside the warming part main body 21. In this case, the ink passing portion through which the ink passes is configured by the ink reservoir. In the embodiment described above, in addition to the ink flow path 21a, an ink reservoir may be formed inside the warming part main body 21. In this case, the ink passing portion through which the ink passes is configured by the ink flow path 21a and the ink reservoir.

### Second Embodiment

A second embodiment of the present invention will be described with reference to the drawings.

The schematic configuration of the inkjet printer 1 is the same as that of the first embodiment shown in FIGS. 1 and 2, and thus the description thereof will be omitted.

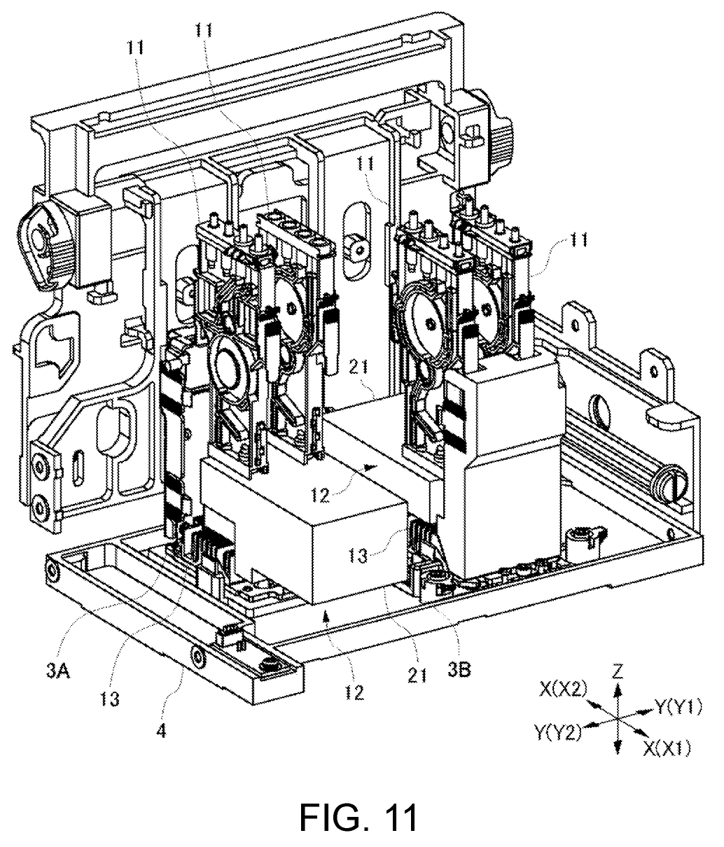

FIG. 11 is a view showing the periphery of the carriage of the inkjet printer according to a second embodiment.

As shown in FIG. 11, in the second embodiment, a pair of inkjet heads (hereinafter, referred to as a “head”) 3A, 3B are mounted on a carriage 4. The pair of heads 3A, 3B are mounted on the carriage 4 while being arranged side by side in the left-right direction (Y direction). In the second embodiment, an ink warming mechanism 12 and a pressure adjustment mechanism 11 are provided in each of the pair of heads 3A and 3B. Note that as an example, the pair of heads 3A and 3B are each mounted on the carriage 4 in opposite directions in the front-back direction. In the following description, when the heads 3A and 3B are collectively described, they are simply referred to as “head 3”.

Configurations of the carriage 4, the ink warming mechanism 12, the pressure adjustment mechanism 11, and the like other than the head 3 are similar to those of the first embodiment, and thus detailed description thereof will be omitted.

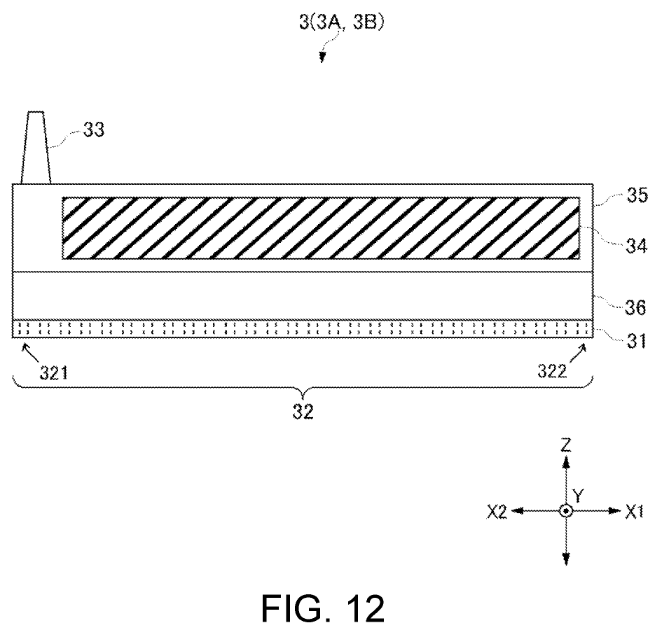

FIG. 12 is a schematic configuration diagram illustrating a side surface of the head 3 of the second embodiment.

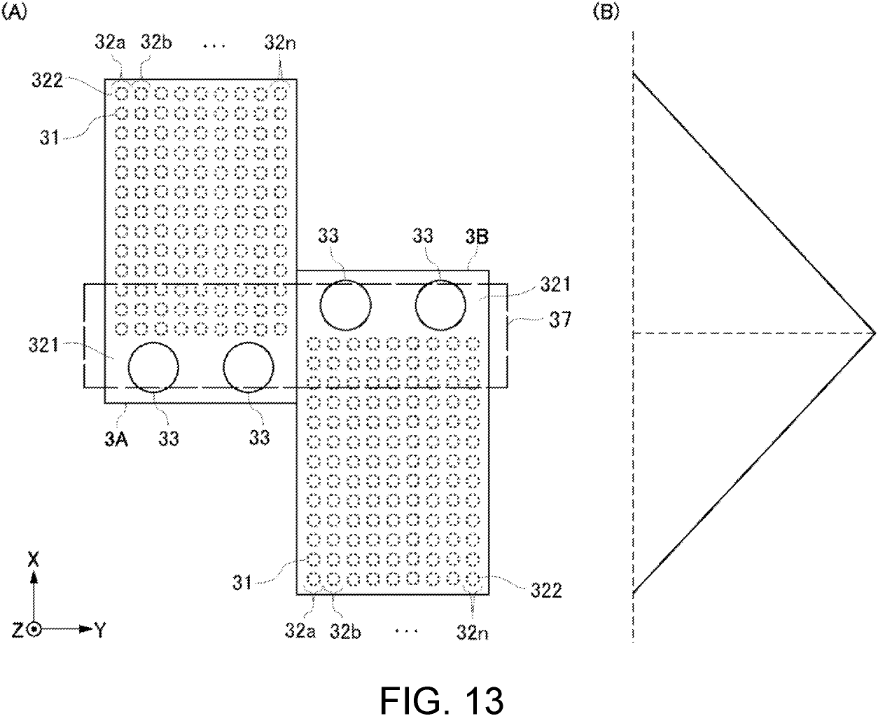

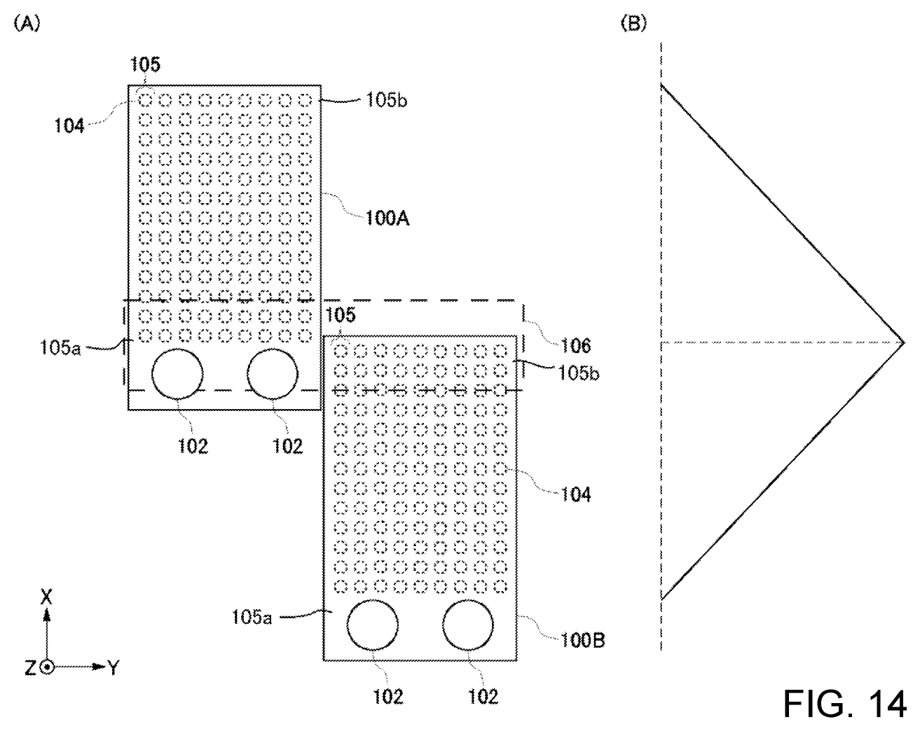

(A) of FIG. 13 is a view showing an arrangement example of the inkjet heads 3A, 3B, and (B) of FIG. 13 is a schematic view showing a usage frequency of a nozzle 31. (A) of FIG. 13 illustrates the inkjet heads 3A and 3B as viewed from above, and shows the nozzle row 32 provided at the lower part of the inkjet head 3 with an imaginary line.

As shown in FIG. 12, the head 3 includes a nozzle row 32 in which a plurality of nozzles 31 are formed along one direction. The head 3 includes an ink supply port 33 formed to be biased toward one end portion 321 of the nozzle row 32, and an ink warming heater 34 that warms the ink. Note that the one direction here is the X direction (sub scanning direction).

Furthermore, an ink front chamber 35 is formed in an upper part of the head 3 of the present embodiment, and an ink ejection chamber 36 is formed in a lower part. An ink supply port 33 is provided at an upper part of the ink front chamber 35. The ink supply port 33 is connected to an ink outflow portion 21e (see FIG. 5) of the warming part main body 21. The ink warmed by the ink warming mechanism 12 (see FIG. 3) flows into the ink front chamber 35 through the ink supply port 33. An ink warming heater 34 is disposed in the ink front chamber 35.

The nozzle row 32 is formed on the lower surface of the ink ejection chamber 36. As shown in (A) of FIG. 13, a plurality of nozzle rows 32a, 32b... 32n extending along one direction (X direction) are arranged side by side in a direction (Y direction) orthogonal to the one direction. Although not illustrated in (A) of FIG. 13, the nozzle row 32 also extends below the ink supply port 33 (see FIG. 12).

As illustrated in FIG. 12, the ink that has flowed into the ink front chamber 35 is warmed by the ink warming heater 34 and supplied to the ink ejection chamber 36. The ink ejection chamber 36 is provided with a piezoelectric element (not illustrated) corresponding to the nozzle 31. When the piezoelectric element is driven, ink is ejected from the nozzle 31.

As illustrated in FIG. 13, the pair of heads 3A and 3B are arranged so as to be shifted in the sub scanning direction (X direction), but a joining site 37 in which a part is close is provided. At the joining site 37, one end portion 321 of the head 3A and one end portion 321 of the head 3B are adjacent in the Y direction (main scanning direction).

Here, the nozzle 31 is formed over the entire lower parts of the heads 3A and 3B. Therefore, the distance from the ink supply port 33 is different for each nozzle 31. For example, as shown in FIG. 12, the nozzles 31 formed on the one end portion 321 side of the nozzle row 32 are close in distance to the ink supply port 33. The nozzles 31 formed on the other end portion 322 side of the nozzle row 32 are far in distance to the ink supply port 33. The ink ejected from the nozzle 31 having a short distance from the ink supply port 33 tends to be warmed by the ink warming heater 34 in a short time. For example, when the environmental temperature of the place where the inkjet printer 1 is installed is low, the ink may be ejected from the nozzle 31 without being sufficiently warmed on the one end portion 321 side close to the ink supply port 33. On the other hand, the ink ejected from the nozzle 31 on the other end portion 322 side is likely to be sufficiently warmed regardless of the environmental temperature as the time for warming is long.

That is, the temperature gradient in which the temperature of the ink in the ink front chamber 35 is lower in the X2 direction (left direction in the drawing) than in the X1 direction (right direction in the drawing) in FIG. 12 may occur. This temperature gradient may affect the print quality of the printer 1.

Here, the influence of the temperature gradient on the print quality will be described with reference to a comparative example of FIG. 14.

(A) of FIG. 14 is a view showing an arrangement example of the heads 100A, 100B of a comparative example, and (B) of FIG. 14 is a schematic view showing a usage frequency of a nozzle 104.

As illustrated in (A) of FIG. 14, the comparative example includes a pair of heads 100A and 100B. A plurality of nozzle rows 105 each arranged side by side in the main scanning direction (Y direction) are provided at the lower part of the heads 100A and 100B. In each nozzle row, a plurality of nozzles 104 for ejecting ink are formed along the sub scanning direction (X direction). The ink supply port 102 is formed to be biased toward one end portion 105 a side of the nozzle row 105.

The pair of heads 100A and 100B are, the head 100A and the head 100B are arranged so as to be shifted from each other in the sub scanning direction (X direction), but a joining site 106 in which a part is close is provided. At the joining site 106, the head 100A and the head 100B are adjacent in the Y direction (main scanning direction).

In the comparative example, the joining site 106 includes one end portion 105 a side where the ink supply port 102 of the nozzle row 105 is formed and the other end portion 105b side where the ink supply port 102 is not formed.

The pair of heads 100A and 100B are driven in the main scanning direction (Y direction) while ejecting ink. Since the heads 100A and 100B are arranged adjacent to each other in the Y direction, for example, after one head 100A performs ejection at a certain position Y1 in the Y direction, the other head moves to the same position Y1 in the Y direction to perform ejection.

The heads 100A and 100B are arranged so as to be shifted in the X direction, but since the joining site 106 is provided, the ink ejected from the nozzle row 105 of the head 100A and the nozzle row 105 of the head 100B at the position Y1 is continuous in the X direction. That is, the heads 100A and 100B are driven in the Y direction, so that the respective nozzle row 105 operates as one nozzle row continuous in the sub scanning direction (X direction).

(B) of FIG. 14 shows the usage frequency of each nozzle 104 when the nozzle row 105 of the heads 100A and 100B is regarded as one nozzle row. In the nozzle row 105, the nozzles 104 in the central region are used more frequently with respect to the sub scanning direction (X direction), and the nozzles 104 in the end region are used less frequently with respect to the sub scanning direction. That is, the joining site 106 which is the central region is a region having a high usage frequency.

Here, the ink is warmed in the heads 100A and 100B of the comparative example, but as described above, the ink temperature of the ink being warmed may vary depending on the region even in the same heads 100A and 100B. Specifically, for example, when the environmental temperature in which the inkjet printer is installed is low, the temperature of the ink in the region close to the ink supply port 102 tends to be low, and the temperature of the ink in the region far from the ink supply port 102 tends to be high. In such a case, the ink having a low temperature ejected from the head 100A and the ink having a high temperature ejected from the head 100B coexist at the joining site 106.

When the temperature of the ink is different, the ejection speed from the nozzle 104 may be different, and the print quality may be affected. That is, the print quality at the joining site 106 where the usage frequency of the nozzle 104 is high may not stabilize, and a stripe pattern having different shades, or a so-called bounding, may occur in the image.

Therefore, as shown in (A) of FIG. 13, in the inkjet printer 1 of the second embodiment, the heads 3A, 3B are arranged adjacent to each other in the direction (Y direction) in which the nozzle rows 32 are arranged side by side such that the one end portions 321 of the nozzle rows 32 of the pair of heads 3A, 3B are close to each other.

That is, the pair of heads 3A and 3B are arranged such that the regions where the temperature of the ink in the head 3 is relatively low are proximate to each other. According to such a configuration, since the pair of heads 3A and 3B are arranged such that the regions where the temperature of the ink in the head 3 is the same are close to each other, an image with more stable quality can be formed even with a device configuration of warming the ink in the head 3.

In the example of (A) of FIG. 13, the pair of heads 3A and 3B are arranged so as to be shifted in the X direction, but may be arranged adjacent to each other in the direction in which the nozzle rows 32 are arranged side by side (Y direction) so that the one end portions 321 of the nozzle rows 32 on the side where the ink supply port 33 is provided are close to each other. That is, in the first embodiment, only one end portion 321 of the nozzle row 32 on the side where the ink supply port 33 is provided is included in the joining site 37 where the heads 3A and 3B are adjacent in the Y direction. The number of nozzles 31 and nozzle rows 32 shown in (A) of FIG. 13 is an example, and this is not the sole case.

Further, in the inkjet printer 1 of the present embodiment, when the pair of heads 3A and 3B are simultaneously driven in the main scanning direction (Y direction), the one end portions 321 or the other end portions 322 of the nozzle row 32 are close to each other so that the nozzle row 32 of each of the pair of heads 3A and 3B can be regarded as the continuous nozzle row 32.

Specifically, the pair of heads 3A and 3B are driven in the main scanning direction (Y direction) while ejecting ink. Since the heads 3A and 3B are arranged adjacent to each other in the Y direction, for example, after one head performs ejection at a certain position Y1 in the Y direction, the other head moves to the same position Y1 in the Y direction to perform ejection.

The heads 3A and 3B are arranged so as to be shifted in the X direction, but since the joining site 37 is provided, the ink ejected from the nozzle row 32 of the head 3A and the nozzle row 32 of the head 3B at the position Y1 is continuous in the X direction. That is, the heads 3A and 3B are driven in the Y direction, so that respective nozzle row 32 operates as one nozzle row continuous in the sub scanning direction (X direction). In the example of (A) of FIG. 13, the nozzle rows 32a, the nozzle rows 32b, ..., and the nozzle rows 32n in the pair of heads 3A and 3B are regarded as the nozzle rows 32 continuous in the sub scanning direction (X direction).

According to such a configuration, printing can be performed on the print medium 2 by a long nozzle row 32 in which the nozzle rows 32 of a pair of heads 3A, 3B are continuous.

Hereinafter, an ink ejection control by an inkjet printer 1 according to the present embodiment will be described with reference to (B) of FIG. 13. The ink ejection control is performed by the controller 9 (see FIG. 2).

The inkjet printer 1 of the present embodiment performs printing through a multi-pass method of performing a plurality of main scans for a plurality of print passes with respect to each position of the print medium 2. The main scan is an operation of ejecting ink droplets onto the print medium 2 while moving the head 3 in the main scanning direction (Y direction). Here, the sub scan is an operation of conveying the print medium 2 in the sub scanning direction (X direction) with respect to the head 3.

Specifically, the inkjet printer 1 performs printing through, for example, a multi-pass method in which the print pass number is N (N is an integer of two or more). The pass number N of printing is, for example, four or more, preferably eight or more. Furthermore, in this case, the nozzles 31 in the nozzle row 32 of each head 3 are assigned according to the respective print pass of the first pass to the N^{th} pass.

For example, when the print pass number is N, each nozzle row 32 is divided into N regions in which the plurality of nozzles 31 arranged in the sub scanning direction are the same in number. Then, the respective print passes of the first pass to N^{th} pass are assigned to the nozzle row 32 divided into the N regions in order from the region that overlaps the print medium 2 first in accordance with the conveyance of the print medium 2 in the sub scan.

Then, the controller 9 sets the movement amount in one sub scan to a pass width, which is the width (width in the sub scanning direction) of the arrangement of the nozzles 31 for one print pass. The pass width is a width in the sub scanning direction of each of the regions divided into N. Since the sub scan is performed between the main scans by the head 3, the controller 9 shifts the region facing the head 3 in the print medium 2 by the pass width every time each main scan is performed. In each main scan, the nozzles 31 in each region in the nozzle row 32 perform printing for the corresponding print pass.

Furthermore, in the control of printing corresponding to each print pass, the controller 9 selects the pixel to which the ink droplet is to be ejected. More specifically, for example, in each of a plurality of print passes performed for each position of the print medium 2, the controller 9 uses mask data, which is data designating a pixel to which an ink droplet is to be ejected, and causes each head 3 to eject the ink droplet to the pixel designated by the mask data. As described above, the controller 9 performs printing through the multi-pass method using the mask data. That is, the controller 9 uses the mask data to control the ejection frequency of the ink ejected from the nozzle row 32 of the head 3 as the ejection control of the head 3 at the time of executing the main scan. Thus, occurrence of bounding formed in the main scanning direction can be suppressed, and an image having a smooth gradation can be formed by controlling the ejection frequency of the ink. As such control of the ejection frequency of ink, Mimaki Advanced Pass System (MAPS) is known.

Here, when performing printing through the multi-pass method using the two heads 3, mask data to become a pattern as shown in (B) of FIG. 13, for example, is used as the mask data used for each of the plurality of print passes. The mask data shown in (B) of FIG. 13 is mask data of a pattern in which the nozzle usage frequency continuously changes in the sub scanning direction, in other words, a pattern in which the concentration of the ink ejected to the print medium 2 continuously changes.

In the mask data shown in (B) of FIG. 13, the nozzle usage frequency (concentration) at the center in the sub scanning direction is set higher than the nozzle usage frequencies on both sides in the sub scanning direction with respect to the two nozzle rows 32 arranged side by side in the sub scanning direction. In other words, in the mask data shown in (B) of FIG. 13, the nozzle usage frequency on the one end portion 321 side (side closer to the ink supply port 33) proximate to the respective nozzle row 32 of the two heads 3A, 3B becomes high, and the nozzle usage frequency on the other end portion 322 side (side farther from the ink supply port 33) of the nozzle row 32 becomes low. In the control of the ink ejection frequency in the present embodiment using the mask data shown in (B) of FIG. 13, a triangular pattern is obtained in which the nozzle usage frequency at the center in the sub scanning direction is set to the maximum (apex), the nozzle usage frequency at both sides in the sub scanning direction is set to zero, and the ink usage frequency decreases constantly from the center toward both sides in the sub scanning direction.

In the present embodiment, the mask data is a triangular pattern, but may be a trapezoidal shape, and the shape of the pattern is not limited if the nozzle usage frequency at the center in the sub scanning direction is set to be higher than the nozzle usage frequency on both sides in the sub scanning direction.

As described above, the head 3 of the present embodiment performs printing on the print medium 2 by the multi-pass method of performing a plurality of main scans for a plurality of print passes with respect to each position of the print medium 2, and in each of the plurality of print passes performed with respect to each position of the print medium 2, uses the mask data, which is the data designating the pixel to which the ink droplet is to be ejected, and ejects the ink droplet to the pixel designated by the mask data.

In the mask data of the present embodiment, the usage frequency of the nozzles 31 on the one end portion 321 side proximate to each other in the nozzle row 32 of the pair of heads 3A and 3B becomes high, and the usage frequency of the nozzles 31 on the other end portion 322 side separated in the nozzle row 32 becomes low.

That is, in the ink ejection control using the mask data of the present embodiment, with the nozzle usage frequency described above, in the example of (A) of FIG. 13, the nozzle 31 having a high nozzle usage frequency becomes the nozzle 31 on the side closer to the ink supply port 33, and the nozzle 31 having a low nozzle usage frequency becomes the nozzle 31 on the side farther away from the ink supply port 33. Therefore, the temperature of the ink ejected from the nozzle 31 having a high nozzle usage frequency becomes relatively low, and the temperature of the ink ejected from the nozzle 31 having a low nozzle usage frequency becomes relatively high.

According to such a configuration, since the temperature of the ink ejected from the nozzles 31 having the same usage frequency is the same, an image with a more stable quality can be formed.

As described above, the second embodiment has been described, but the technical scope of the present invention is not limited to the scope described in the above embodiment. Various changes or improvements can be added to the embodiment described above without deviating from the scope of the invention, and a mode in which changes or improvements are added is also encompassed within the technical scope of the present invention.

In (A) of FIG. 13 of the second embodiment, a mode in which the pair of heads 3A and 3B are arranged such that the end portions 321 of the nozzle row 32 on the side where the ink supply port 33 is provided are proximate to each other has been described, but the present invention is not limited thereto.

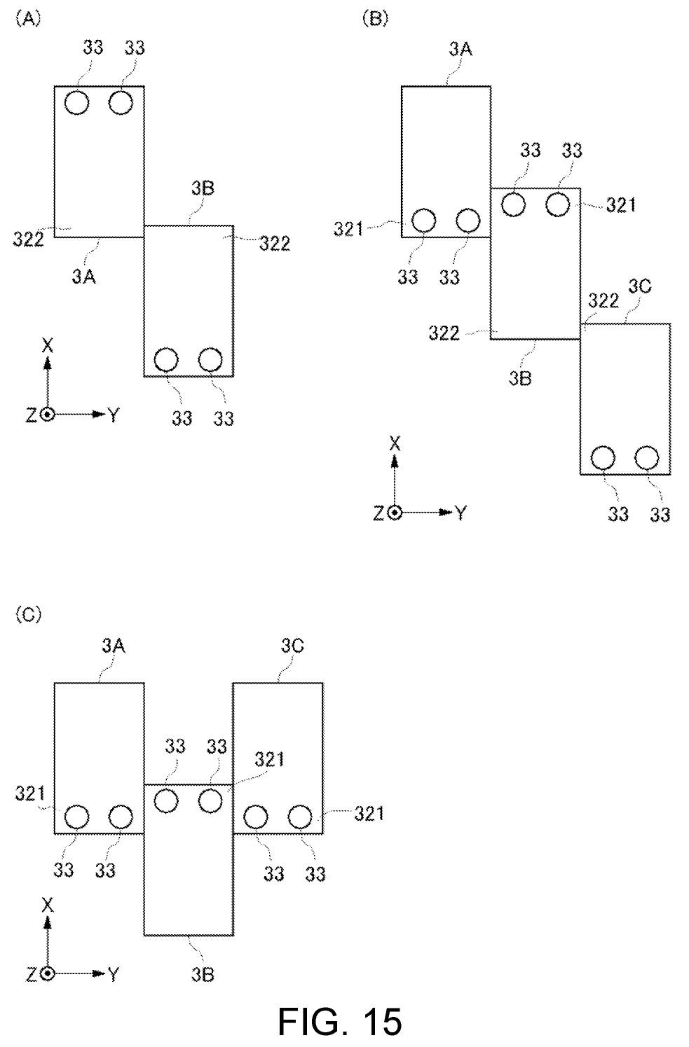

FIG. 15 is a view showing another arrangement example of a plurality of inkjet heads 3. In FIG. 15, illustration of the nozzles 31 and the nozzle row 32 is omitted.

In the example of (A) of FIG. 15, the pair of heads 3A and 3B are arranged such that the end portions 322 of the nozzle row 32 on the side where the ink supply port 33 is not provided are proximate to each other.

The examples of (B) and (C) of FIG. 15 are an example in which the inkjet printer 1 includes three heads 3A, 3B, and 3C. In the examples of (B) and (C) of FIG. 15, the heads 3A and 3B are paired, and the heads 3B and 3C are paired.

In the example of (B) of FIG. 15, the pair of heads 3A and 3B are arranged such that the end portions 321 of the nozzle row 32 on the side where the ink supply port 33 is provided are proximate to each other. Furthermore, the pair of heads 3B and 3C are arranged such that the end portions 322 of the nozzle row 32 on the side where the ink supply port 33 is not provided are proximate to each other.

In the example of (C) of FIG. 15, the pair of heads 3A and 3B and the pair of heads 3B and 3C are both arranged such that the end portions 321 of the nozzle row 32 on the side where the ink supply port 33 is provided are proximate to each other.

The inkjet printer 1 of the second embodiment has been described for a mode of performing printing on the print medium 2 by moving the head 3 with respect to the print medium 2, but the present invention is not limited thereto. The printing may be performed while moving the print medium 2 with respect to the head 3, or the printing may be performed while moving both the head 3 and the print medium 2.

### Main Effects of Second Embodiment

(1) The inkjet printer 1 of the present embodiment includes a plurality of heads (inkjet heads) 3A, 3B that eject ink, and performs printing on the print medium 2 by relatively moving the heads 3A, 3B with respect to the print medium 2.

The heads 3A and 3B include a nozzle row 32 in which a plurality of nozzles 31 are formed along the X direction (one direction), an ink supply port 33 formed on one end portion 321 side of the nozzle row 32, and an ink warming heater 34 that warms the ink.

The pair of heads 3A and 3B are arranged adjacent to each other in the Y direction (direction orthogonal to the one direction) such that the one end portions 321 of the nozzle row 32 or the other end portions 322 of the nozzle row 32 are proximate to each other.

According to the present embodiment, since the pair of heads 3A and 3B are arranged such that the regions where the temperature of the ink in the head 3 is the same are proximate to each other, an image with a more stable quality can be formed even with a device configuration of warming the ink in the head 3.

(2) In the inkjet printer 1 of the present embodiment, when the pair of heads 3A and 3B are simultaneously driven, the one end portions 321 or the other end portions 322 of the nozzle row 32 are close to each other so that the nozzle row 32 of each of the pair of heads 3A and 3B can be regarded as a continuous nozzle row 32. According to the present embodiment, printing can be performed on the print medium 2 by a long nozzle row 32 in which the nozzle rows 32 of a pair of heads 3A, 3B are continuous.

(3) In the inkjet printer 1 of the present embodiment, the head 3 performs printing on the print medium 2 by a multi-pass method of performing a plurality of main scans for a plurality of print passes with respect to each position of the print medium 2, and in each of the plurality of print passes performed with respect to each position of the print medium 2, uses mask data, which is the data designating the pixel to which the ink droplet is to be ejected, and ejects the ink droplet to the pixel designated by the mask data, where the mask data is set so that the usage frequency of the nozzle 31 on one end portion 321 side proximate to each other in the nozzle row 32 of the pair of heads 3A, 3B becomes high and the usage frequency of the nozzle 31 on the other end portion 322 side separated in the nozzle row 32 becomes low. According to the present embodiment, since the temperature of the ink ejected from the nozzles 31 having the same usage frequency is the same, an image with a more stable quality can be formed.

(4) In the inkjet printer 1 of the present embodiment, the pair of heads 3A and 3B are arranged such that regions where the temperature of the ink in the head 3 is relatively low or regions where the temperature of the ink in the head 3 is relatively high are proximate to each other. According to the present embodiment, an image with a more stable quality can be formed when the ink is warmed in the head 3.

In the first embodiment and the second embodiment described above, the printer 1 may include a sub tank that contains the ink to be supplied to the head 3 instead of the pressure adjustment mechanism 11. Furthermore, in the embodiment described above, the printer 1 may include, instead of the platen 8, a table on which the print medium 2 is placed, and a table drive mechanism that moves the table in the front-back direction. In addition, in the embodiment described above, the printer 1 may be a 3D printer that shapes a three-dimensional object. In the embodiment described above, the ink ejected by the head 3 may be an aqueous ink or a solvent ink.

### REFERENCE SIGNS LIST

1 Printer (inkjet printer)
3, 3A, 3B Head (inkjet head)
10 External temperature sensor (second temperature sensor)
11 Pressure adjustment mechanism
12 Ink warming mechanism
15 Ink flow path (second ink flow path)
21 Warming part main body
21a Ink flow path (ink passing portion)
21c Accommodating portion (pressure adjustment mechanism accommodating portion)
21f Heater attaching portion
21g Sensor attaching portion
32 Heater
23 Warming part temperature sensor (temperature sensor)
24 Heater controller
31 Nozzle
32 Nozzle row
33 Ink supply port
34 Ink warming heater

1. An inkjet printer comprising an inkjet head that ejects ink; and an ink warming mechanism that warms ink supplied to the inkjet head, wherein
the ink warming mechanism includes:
a warming part main body being block-shaped;
an ink passing portion that is formed inside the warming part main body and through which ink passes;
a heater that is attached to the warming part main body and heats the warming part main body;
a temperature sensor that is attached to the warming part main body and detects a temperature of the warming part main body; and
a heater controller that controls the heater;
the ink passing portion is configured by at least one of an ink flow path through which ink flows and an ink reservoir in which ink is accumulated; and
the heater controller controls the heater based on a detection result of the temperature sensor so that a temperature of the warming part main body becomes a predetermined reference temperature, calculates a temperature reduction amount of the warming part main body due to an influence of the ink flowing into the ink passing portion based on a detection result of the temperature sensor after the inkjet head starts ejecting the ink, and updates the reference temperature based on the calculated temperature reduction amount.

2. The inkjet printer as set forth in claim 1, further comprising:
a second temperature sensor for detecting an external temperature of the inkjet printer, wherein
the heater controller initially sets the reference temperature based on a detection result of the second temperature sensor before ink is ejected from the inkjet head.

3. A method for controlling an inkjet printer comprising an inkjet head that ejects ink; and an ink warming mechanism that warms ink supplied to the inkjet head,
the ink warming mechanism including,
a warming part main body being block-shaped;
an ink passing portion that is formed inside the warming part main body and through which ink passes;
a heater that is attached to the warming part main body and heats the warming part main body; and
a temperature sensor that is attached to the warming part main body and detects a temperature of the warming part main body; and
the ink passing portion being configured by at least one of an ink flow path through which ink flows and an ink reservoir in which ink is accumulated; wherein
the heater is controlled based on a detection result of the temperature sensor so that a temperature of the warming part main body becomes a predetermined reference temperature, a temperature reduction amount of the warming part main body due to an influence of the ink flowing into the ink passing portion is calculated based on a detection result of the temperature sensor after the inkjet head starts ejecting the ink, and the reference temperature is updated based on the calculated temperature reduction amount of the warming part main body.

4. An inkjet printer comprising an inkjet head that ejects ink; and an ink warming mechanism that warms ink supplied to the inkjet head, wherein
the ink warming mechanism includes:
a warming part main body being block-shaped;
an ink passing portion that is formed inside the warming part main body and through which ink passes;
a heater that is attached to the warming part main body and heats the warming part main body;
a temperature sensor that is attached to the warming part main body and detects a temperature of the warming part main body; and
a heater controller that controls the heater based on a detection result of the temperature sensor;
the ink passing portion is configured by at least one of an ink flow path through which ink flows and an ink reservoir in which ink is accumulated;
the warming part main body includes a heater attaching portion where the heater is to be attached and a sensor attaching portion where the temperature sensor is to be attached; and
when a flow direction of ink flowing into the ink passing portion is an ink flow direction, the sensor attaching portion is provided to project out toward an upstream side in the ink flow direction of the heater attaching portion.

5. The inkjet printer as set forth in claim 4, further comprising:
a pressure adjustment mechanism that contains the ink to be supplied to the ink passing portion and adjusts a pressure of the ink to be supplied to the inkjet head, wherein
at least a part of the pressure adjustment mechanism is accommodated in the warming part main body,
a second ink flow path through which ink flows is formed inside the pressure adjustment mechanism, and
the sensor attaching portion is provided in proximity to the second ink flow path.

6. The inkjet printer as set forth in claim 5, wherein the warming part main body includes an accommodating portion in which a part of the pressure adjustment mechanism is accommodated, and
the sensor attaching portion constitutes a part of the accommodating portion.

7. The inkjet printer as set forth in claim 5, wherein
the pressure adjustment mechanism is disposed on an upper side of the ink passing portion, and
the sensor attaching portion is disposed on an upper side of the heater attaching portion.

8. An inkjet printer that includes a plurality of inkjet heads that eject ink, and that relatively moves the plurality of inkjet heads with respect to a print medium to perform printing on the print medium; wherein
the plurality of inkjet heads include,
a nozzle row in which a plurality of nozzles are formed along one direction;
an ink supply port formed on one end portion side of the nozzle row; and
an ink warming heater that warms the ink; and
a pair of inkjet heads are arranged adjacent to each other in a direction orthogonal to the one direction such that one end portions of the nozzle row or the other end portions of the nozzle row are proximate to each other.

9. The inkjet printer as set forth in claim 8, wherein when the pair of inkjet heads are driven simultaneously, the one end portions or the other end portions of the nozzle row are proximate to each other so that respective nozzle rows of the pair of inkjet heads are regarded as a continuous nozzle row.

10. The inkjet printer as set forth in claim 8, wherein
the inkjet head performs printing on the print medium through a multi-pass method of performing a plurality of main scans for a plurality of print passes with respect to each position of the print medium, and in each of the plurality of print passes performed with respect to each position of the print medium, uses mask data, which is data designating a pixel to which ink droplet is to be ejected, and ejects the ink droplet to the pixel designated by the mask data; and
the mask data is set so that a usage frequency of the nozzle on one end portion side proximate to each other in the nozzle row of the pair of inkjet heads becomes high and a usage frequency of the nozzle on the other end portion side separated in the nozzle row becomes low.

11. The inkjet printer as set forth in claim 8 wherein the pair of inkjet heads are arranged such that regions where a temperature of the ink in the inkjet head is relatively low or regions where a temperature of the ink in the inkjet head is relatively high are proximate to each other.

12. The inkjet printer as set forth in claim 6, wherein
the pressure adjustment mechanism is disposed on an upper side of the ink passing portion, and
the sensor attaching portion is disposed on an upper side of the heater attaching portion.

13. The inkjet printer as set forth in claim 9, wherein
the inkjet head performs printing on the print medium through a multi-pass method of performing a plurality of main scans for a plurality of print passes with respect to each position of the print medium, and in each of the plurality of print passes performed with respect to each position of the print medium, uses mask data, which is data designating a pixel to which ink droplet is to be ejected, and ejects the ink droplet to the pixel designated by the mask data; and
the mask data is set so that a usage frequency of the nozzle on one end portion side proximate to each other in the nozzle row of the pair of inkjet heads becomes high and a usage frequency of the nozzle on the other end portion side separated in the nozzle row becomes low.

14. The inkjet printer as set forth in claim 9, wherein the pair of inkjet heads are arranged such that regions where a temperature of the ink in the inkjet head is relatively low or regions where a temperature of the ink in the inkjet head is relatively high are proximate to each other.

15. The inkjet printer as set forth in claim 10, wherein the pair of inkjet heads are arranged such that regions where a temperature of the ink in the inkjet head is relatively low or regions where a temperature of the ink in the inkjet head is relatively high are proximate to each other.
